(19) United States
(12) Patent Application Publication
(10) Pub. No.: US 2017/0213277 A1
(43) Pub. Date: Jul. 27, 2017

(54) GOODS PURCHASE APPARATUS AND GOODS PURCHASE SYSTEM HAVING THE SAME

(71) Applicant: LG ELECTRONICS INC., Seoul (KR)

(72) Inventors: Sukhyun HONG, Seoul (KR); Hyunju LEE, Seoul (KR); Hotaek HONG, Seoul (KR); Chul LEE, Seoul (KR)

(73) Assignee: LG ELECTRONICS INC., Seoul (KR)

(21) Appl. No.: 15/327,942

(22) PCT Filed: Jun. 24, 2015
(86) PCT No.: PCT/KR2015/006414

§ 371 Date: Jan. 20, 2017

(30) Foreign Application Priority Data
Jul. 21, 2014 (KR) 10-2014-0091827

(51) Int. Cl. G06Q 30/06; G06K 9/00; G06Q 10/08

(52) U.S. Cl. CPC G06Q 30/0635; G06Q 30/0643; G06Q 10/083; G06K 9/00013

(57) ABSTRACT

Disclosed herein are a goods purchase apparatus and a goods purchase system having the same. The goods purchase apparatus includes a communication unit, when the goods purchase apparatus is tagged with a user's membership card or mobile terminal, to receive user information from the membership card or the mobile terminal, an image capture unit to scan images representing information related to goods in a mart or goods displayed on a digital signage, and a controller to control to transmit the user information to a server, to extract goods information based on the scanned images, and to control to transmit goods purchase information corresponding to the goods information to the server. Thereby, the user may conveniently shop in the mart.

### TECHNICAL FIELD

The present invention relates to a goods purchase apparatus and a goods purchase system having the same and, more particularly, to a goods purchase apparatus allowing a user to simply shop at a mart and a goods purchase system having the same.

### BACKGROUND ART

In general, goods purchase apparatuses are apparatuses allowing a user to purchase goods and, for example, include a terminal for online shopping.

Online shopping may reduce time and costs, as compared to offline shopping, but forces a user to purchase a product without directly viewing the product.

As to offline shopping, shopping at a mart allows a user to purchase a product while actually viewing the product but requires a long time. Particularly, busy workers tend to visit marts to shop on weekends rather than weekdays.

### DISCLOSURE

### Technical Problem

it is an object of the present invention to provide a goods purchase apparatus allowing a user to conveniently shop at a mart and a goods purchase system having the same.

### Technical Solution

To achieve the above objects, there is provided a goods purchase apparatus according to an exemplary embodiment of the present invention, including a communication unit, when the goods purchase apparatus is tagged with a user's membership card or mobile terminal, to receive user information from the membership card or the mobile terminal, an image capture unit to scan images representing information related to goods in a mart or goods displayed on a digital signage, and a controller to control to transmit the user information to a server, to extract goods information based on the scanned images, and to control to transmit goods purchase information corresponding to the goods information to the server.

To achieve the above objects, there is provided a goods purchase system according to an exemplary embodiment of the present invention, including a digital signage disposed in a shopping zone in a mart and to provide a plurality of goods images and information related to the plurality of goods images, a goods purchase apparatus to scan images representing information related to goods in the mart or goods displayed on the digital signage or transmit goods purchase information to the outside based on a user's voice, a server to store a goods purchase list based on the goods purchase information, and a calculation apparatus to receive the goods purchase list from the server, to divisionally display goods to be delivered and goods to be carried directly among the goods purchase list, and to perform payment for the goods purchase list.

### Advantageous Effects

As apparent from the above description, a goods purchase apparatus in accordance with one embodiment of the present invention includes a communication unit, when the goods purchase apparatus is tagged with a user's membership card or mobile terminal, to receive user information from the membership card or the mobile terminal, an image capture unit to scan images representing information related to goods in a mart or goods displayed on a digital signage, and a controller to control to transmit the user information to a server, to extract goods information based on the scanned images, and to control to transmit goods purchase information corresponding to the goods information to the server, thereby allowing the user to conveniently make a goods purchase list through the server and thus to conveniently shop in the mart.

Further, the goods purchase apparatus transmits goods purchase number information or goods purchase cancellation information, based on a user's voice input through an audio input unit, to the server, thereby allowing the user to more conveniently make the goods purchase list and thus to conveniently shop in the mart.

Further, a goods purchase system in accordance with one embodiment of the present invention includes a digital signage disposed in a shopping zone in a mart and to provide a plurality of goods images and information related to the plurality of goods images, a goods purchase apparatus to scan images representing information related to goods in the mart or goods displayed on the digital signage or transmit goods purchase information to the outside based on a user's voice, a server to store a goods purchase list based on the goods purchase information, and a calculation apparatus to receive the goods purchase list from the server, to divisionally display goods to be delivered and goods to be carried directly among the goods purchase list, and to perform payment for the goods purchase list, thereby allowing the user to easily divide purchased goods into goods to be directly carried and goods to be delivered.

Further, the user may conveniently shop using the goods purchase apparatus handy to carry without a separate cart.

The digital signage may display images of goods, which are not displayed in a goods display stand, together with various pieces of information. The goods purchase system may provides images of various goods and various pieces of information of the goods through such a digital signage and thus reduce the size of an actual goods display stand.

Since the overall area of the mart may be reduced through the digital signage, a mart operator may provide a new type of mart, in which online advantages and offline advantages are combined, in a building having a small area at a district with a lot of floating population.

Further, since users, who have conveniently ridden in cars and purchased goods at marts, may make a goods purchase list through recognition of barcode images and QR code images of goods using the goods purchase apparatus and goods corresponding the goods purchase list may be delivered to homes, the users may conveniently perform shopping during working hours or lunch breaks on weekdays rather than on weekends or at night.

### DESCRIPTION OF DRAWINGS

The above and other objects, features and other advantages of the present invention will be more clearly understood from the following detailed description taken in conjunction with the accompanying drawings, in which:

FIG. 1 is a view illustrating a goods purchase system in accordance with one embodiment of the present invention;

FIG. 2 is a view illustrating a goods purchase flow at a mart of FIG. 1;

FIG. 3 is a view exemplarily illustrating use of an entrance zone of FIG. 1 by users;

FIG. 4A is a view exemplarily illustrating a theme zone in a shopping zone of FIG. 1;

FIG. 4B is a view exemplarily illustrating a variety zone in the shopping zone of FIG. 1;

FIG. 5A is a view exemplarily illustrating a self checkout counter in a counter zone of FIG. 1;

FIG. 5B is a view exemplarily illustrating a helper counter in the counter zone of FIG. 1;

FIG. 6 is a view illustrating a goods purchase and delivery flow;

FIGS. 7A and 7B are views illustrating division of goods into goods to be delivered and goods to be directly carried through a goods purchase list, when purchase of the goods has been completed;

FIG. 7C is a view exemplarily illustrating an online order payment image;

FIG. 7D is a view exemplarily illustrating a final payment image; ( [symbol] )

FIGS. 8(a) to 8(c) are views exemplarily illustrating various user authentication methods using a goods purchase apparatus;

FIGS. 9A to 9C are views exemplarily illustrating various examples of purchase of goods using the goods purchase apparatus;

FIG. 10 is one exemplary block diagram illustrating the inside of a goods purchase apparatus of FIG. 1;

FIG. 11 is one exemplary block diagram illustrating the inside of a mobile terminal of FIG. 1;

FIGS. 12A to 19 are views illustrating a method for purchasing goods;

FIG. 20 is one exemplary block diagram illustrating a digital signage of FIG. 1;

FIG. 21 is a view exemplarily illustrating the concept of a digital signage having an image projection module in accordance with one embodiment of the present invention;

FIG. 22 is one exemplary block diagram briefly illustrating the inside of the image projection module of FIG. 21;

FIG. 23 is a view illustrating simultaneous output of a projected image and light for distance detection from the image projection module of FIG. 21;

FIGS. 24A and 24B are views illustrating sensing of touch input and gesture input by the image projection module of FIG. 21; and

FIGS. 25A(a), 25A(b), and 25B are views illustrating a distance detection method in the image projection module of FIGS. 24A and 24B.

### BEST MODE

The advantages and features of the present invention, and the way of attaining them, will become apparent with reference to embodiments described below in conjunction with the accompanying drawings. Reference will now be made in detail to the preferred embodiments of the present invention, examples of which are illustrated in the accompanying drawings. Wherever possible, the same reference numbers will be used throughout the drawings to refer to the same or like parts.

The suffixes “module” and “unit” in elements used in description below are only given in consideration of ease in preparation of the specification and do not provide specific meanings or functions. Therefore, the suffixes “module” and “unit” may be used together.

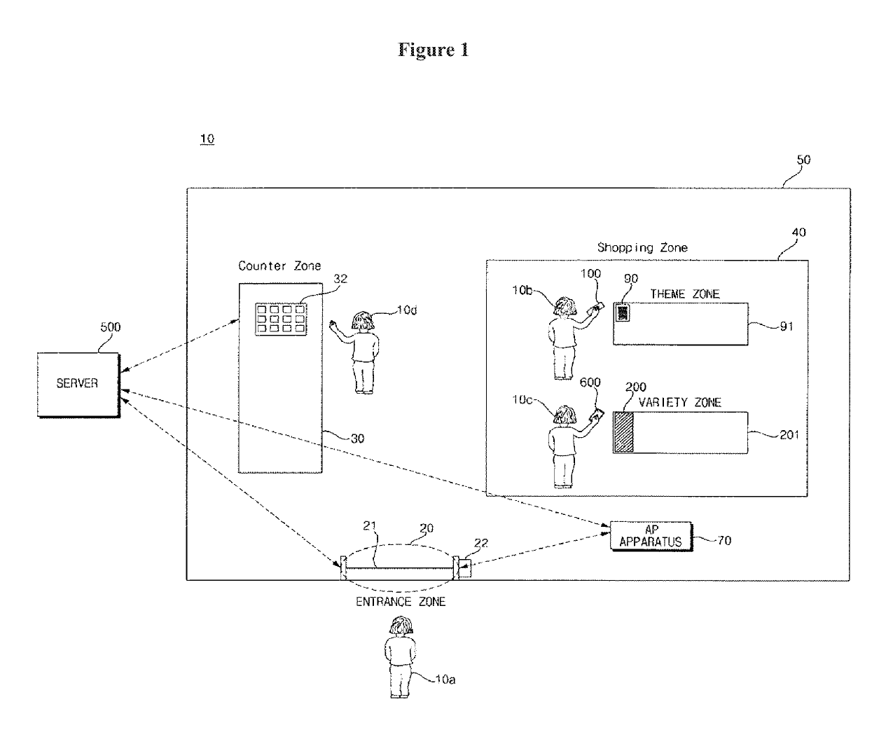

FIG. 1 is a view illustrating a goods purchase system in accordance with one embodiment of the present invention.

With reference to FIG. 1, a goods purchase system 10 in accordance with one embodiment of the present invention is a system to purchase goods at an offline mart 50, and the goods purchase system 10 may include goods purchase apparatuses 100, mobile terminals 600, a server 500, purchased goods calculation apparatuses 32, an entry authentication apparatus 22, and AP apparatuses 70.

The entry authentication apparatus 22 may be installed around a gate 21 of the mart 50 and serve to authenticate entry or exit of a user 10 into or from an entrance zone 22.

The entry authentication apparatus 22 may receive user information and perform user authentication through the received user information.

Otherwise, the entry authentication apparatus 22 may receive user information and transmit the received user information to the server 500, and the server 500 may perform user authentication based on the user information.

As methods of receiving user information, user information may be received from a user's membership card related to the mart 50 wirelessly, user information may be received from a user's mobile terminal 600 wirelessly, or a user's fingerprint may be scanned and corresponding user information may be received from the scanned fingerprint image.

As wireless methods, RFID or NFC communication methods may be exemplarily used and other modifications may be employed.

A plurality of goods purchase apparatuses 100 may be provided around the gate 21 of the mart 50 and a user may pick up one goods purchase apparatus 100.

The goods purchase apparatus 100 may receive user information from a user's membership card related to the mart 50 wirelessly through an image capture unit of the goods purchase apparatus 100 and transmit the received user information to the entry authentication apparatus 22 or the server 500.

Otherwise, the goods purchase apparatus 100 may scan a user's fingerprint through the image capture unit of the goods purchase apparatus 100 and transmit the scanned fingerprint image to the entry authentication apparatus 22 or the server 500.

If the goods purchase apparatus 100 transmits the user information to the server 500 and receives ID information from the server 500 and then, the user enters into the entrance zone while holding the goods purchase apparatus 100 and passes through the gate 22, the goods purchase apparatus 100 may transmit the user information or the ID information to the entry authentication apparatus 22. Further, the entry authentication apparatus 22 may transmit the user information of the ID information to the server 500. Thereby, the server 500 may recognize that the corresponding user enters into the mart 50.

If a mart related application is installed in the user's mobile terminal 600, when the user passes through the gate 22, the mart related application installed in the user's mobile terminal 600 may be executed or activated by a signal from the entry authentication apparatus 22 and user information may be transmitted to the entry authentication apparatus 22 or the server 500. After the user 10a passes through the entrance zone 20 of the mart 50 and enters into the mart 50, the user 10a may move to a shopping zone 40 and perform shopping. Then, after shopping has been completed, the user 10a may move to a counter zone 30 and perform calculation of purchased goods.

The shopping zone 40 may include a theme zone and a variety zone.

In the theme zone, goods display stands are divided into various packages according to brands or prices and various promotions, such as a customized package or a recommended package, may be carried out. The goods display stand may include information display units 90 displaying price information of respective goods together with the goods. The information display unit 90 may include barcode images, QR code images, etc., including price information.

The information display unit 90 may be implemented as a display device and display various pieces of information, such as product name information, expiration date information, and similar goods information, in addition to the price information.

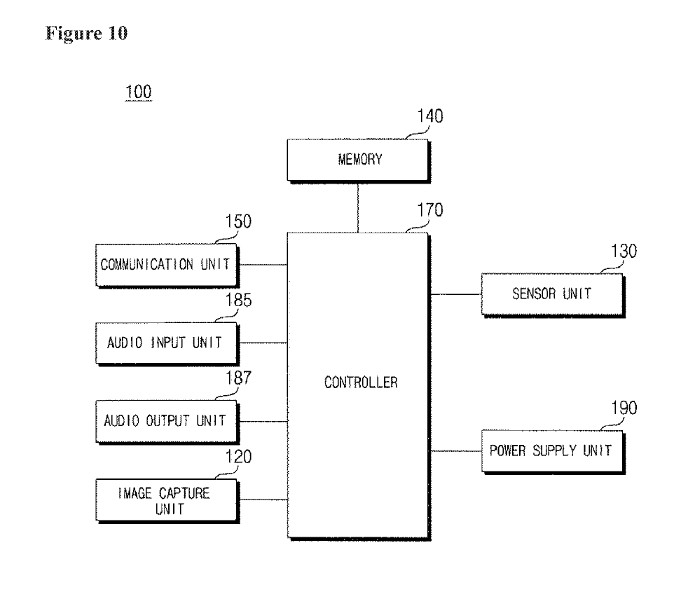

The user may purchase respective goods arranged on the goods display stand using the image capture unit 120 (in FIG. 10) of the goods purchase apparatus 100. That is, if the image capture unit 120 (in FIG. 10) of the goods purchase apparatus 100 recognizes a barcode image or a QR code image, etc., corresponding goods may be added to a purchase list.

Goods purchase list information acquired by purchasing goods may be processed by the goods purchase apparatus 100 and transmitted to the user's mobile terminal 600 interlocked with the goods purchase apparatus 100 or be transmitted to the server 500 operated by a mart operator. Whenever the image capture unit 120 (in FIG. 10) of the goods purchase apparatus 100 recognizes a barcode image or a QR code image, the number of goods desired to purchase may be increased.

If the image capture unit 120 (in FIG. 10) of the goods purchase apparatus 100 recognizes a barcode image or a QR code image and then a user's voice indicating the purchase number of goods is input through an audio input unit 185 (in FIG. 10), the purchase number of the corresponding goods may be determined.

If the image capture unit 120 (in FIG. 10) of the goods purchase apparatus 100 recognizes a barcode image or a QR code image for a designated time or more, purchase of corresponding goods may be canceled.

For example, if the image capture unit 120 (in FIG. 10) of the goods purchase apparatus 100 recognizes a barcode image or a QR code image for 5 seconds or more, purchase of corresponding goods may be canceled.

Further, if the image capture unit 120 (in FIG. 10) of the goods purchase apparatus 100 recognizes a barcode image or a QR code image and then a user's voice indicating the purchase cancellation number of goods is input through the audio input unit 185 (in FIG. 10), the purchase cancellation number of the corresponding goods may be determined.

In the variety zone, online mall goods information may be confirmed and a customer information-based customized advertisement and promotion may be performed. In the variety zone, in addition to goods display stands, digital signages 200, on which online information, customer-based information, and promotion information are displayed, may be provided.

The digital signage 200 is an image display device which may display various goods images and at least one of mart provided price information, online mall price information, similar goods information, customer-based recommended goods information and mart provided promotion information thereof.

Further, the digital signage 200 may display images of goods, which are not displayed in the goods display stand, together with various pieces of information. The digital signage 200 may provide images and various pieces of information of various goods and thus reduce the actual size of the goods display stand.

Since the overall area of the mart 50 may be reduced through such a digital signage 200, a mart operator may provide a new type of mart, in which online advantages and offline advantages are combined, in a building having a small area at a district with a lot of floating population.

Further, since users, who have conveniently ridden in cars and purchased goods at marts, may make a goods purchase list through recognition of barcode images and QR code images of goods and goods corresponding the goods purchase list may be delivered to homes, the users may conveniently perform shopping during working hours or lunch breaks on weekdays rather than on weekends or at night.

The digital signage 200 may display barcode images and QR code images of goods together with goods images. Therefore, if the image capture unit 120 (in FIG. 10) of the goods purchase apparatus 100 recognizes a barcode image or a QR code image, corresponding goods may be added to the goods purchase list.

Goods purchase list information acquired by purchasing goods may be processed by the goods purchase apparatus 100 and transmitted to the user's mobile terminal 600 interlocked with the goods purchase apparatus 100 or the server 500 operated by a mart operator.

Further, the number of goods desired to purchase may be set or purchased goods may be canceled by recognizing a barcode image or a QR code image or recognizing a user's voice through the goods purchase apparatus 100.

When a user moves within the shopping zone 40, for example, within the variety zone, user customized goods information according to user's position information may be provided. If the user is located at a first goods display stand, the digital signage 200 located adjacent to the first goods display stand may provide information of goods promoted by the mart operator or preferred by users, among various goods located in the first goods display stand.

Here, the goods information may include at least one of price information at the corresponding mart 50, goods kind information, goods manufacturing date information, price information at other marts or online shopping malls.

The position information of the user 10c may be acquired through a plurality of AP apparatuses 70 arranged in the mart 50. The goods purchase apparatus 100 may be connected to the plurality of AP apparatuses 70 arranged in the mart 50 so as to communicate with the server 50. The server 500 may receive position information, connection information, etc. from the AP apparatus 70 connected to the goods purchase apparatus 70 among the plurality of AP apparatuses 70 and acquire the position of the user based on the received position information, connection information, etc.

Further, in response to the acquired position, the server 500 transmits goods information to be provided to the user to the digital signage 200 adjacent to the position of the user through the AP apparatuses 700. Thereby, the digital signage 200 may display user customized goods information received from the server 500.

When the user performs goods purchase in the shopping zone 40, the user may directly select goods to be carried by the user from the goods display stand and thus add the goods to the purchase list, and may only add goods to be delivered to the purchase list.

After purchase of goods has been completed, the user 10d may move to the counter zone.

The user 10d may directly perform payment for purchased goods on a self checkout counter or perform payment for purchased goods on a helper counter through a helper.

For example, the goods purchase list may be transmitted from the goods purchase apparatus 100 carried by the user, the user's mobile terminal 600, or the server 500 to the calculation apparatus 32 located on the self checkout counter or the helper counter through wireless communication between the goods purchase apparatus 100, the mobile terminal 600 or a membership card possessed by the user, and the calculation apparatus 32, and payment for the purchased goods may be performed by the calculation apparatus 32.

Here, the goods purchase list may be displayed by the calculation apparatus 32 and the user may perform purchase decision/cancellation by purchase decision/cancellation input.

Otherwise, if a image to divide goods into goods to be delivered to home and goods to be directly carried by the user is displayed by the calculation apparatus 32, the goods to be delivered and the goods to be directly carried may be divided from each other by user input.

Here, goods to be directly carried, which are set in advance, have been contained in a cart but goods to be directly carried, which are determined additionally, may be moved from the shopping zone 40 or a storehouse (not shown) to the counter zone 30 with the aid of mart staff. Thereby, shopping desired by the user may be performed.

Particularly, in case of fresh foods, in order to maintain freshness, the user may receive the fresh foods in the counter zone 30 and thus directly carry the fresh foods, and user convenience may be increased. That is, the user may freely move and only prepare a goods purchase list without a separate cart during shopping and then may receive necessary goods in the counter zone 30.

Differently, if the user exits through the entrance zone 22, payment for purchased goods may be performed through the entry authentication apparatus 22.

If the goods purchase apparatus 100 transmits user information to the server 500 and receives ID information from the server 500 and then the user enters into the entrance zone 22 with the goods purchase apparatus 100 and passes through the gate 22, the goods purchase apparatus 100 may transmit the user information or the ID information to the entry authentication apparatus 22.

For example, if the user exits through the entrance zone 22, the goods purchase apparatus 100 may transmit the user information or the ID information to the entry authentication apparatus 22 and the entry authentication apparatus 22 may transmit the user information or the ID information to the server 500 and receive the goods purchase list of the corresponding user from the server 500.

Then, the entry authentication apparatus 22 may automatically perform payment for the goods purchase list using a membership card, which is set in advance, or the mobile terminal 600.

Thereby, payment for purchased goods may be carried out in the entrance zone 22 rather than the counter zone.

Further, purchase decision/cancellation and division of purchased goods into goods to be delivered and goods to be directly carried may be performed through the entry authentication apparatus 22.

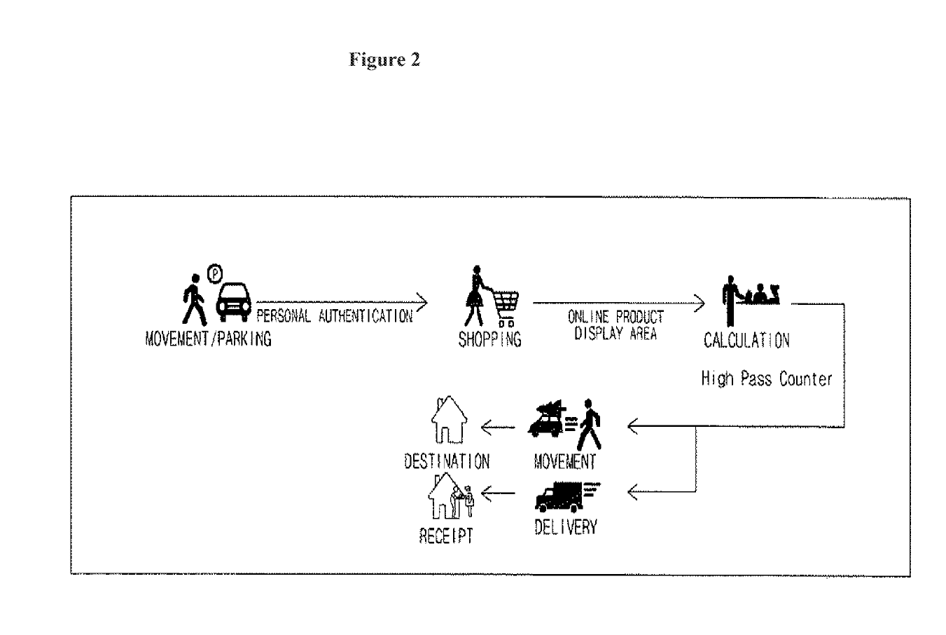

Hereinafter, the goods purchase system 10 in accordance with one embodiment of the present invention will be described in more detail with reference to FIG. 2.

FIG. 2 is a view illustrating a goods purchase flow at the mart of FIG. 1.

With reference to FIG. 2, when a user 10 moves and passes through the entrance zone 22 of the mart 50, user authentication is performed through the entry authentication apparatus 22. Here, the user may pick up the goods purchase apparatus 100 to purchase goods.

Then, if the user holding the goods purchase apparatus 100 moves to the shopping zone 40, the user may select goods to be purchased and generate a goods purchase list using the goods purchase apparatus 100.

Thereafter, if the user enters into the counter zone 30, payment for the goods purchase list may be performed through communication between the goods purchase apparatus 100 and the calculation apparatus 32 in the counter zone 30. At this time, the user may finally divide the purchased goods into goods to be directly carried and goods to be delivered. Thereby, the goods selected to be directly carried, such as fresh foods, may be directly carried by the user and the goods to be delivered may be delivered to a delivery place by a vehicle provided by the mart. Since such a goods purchase system 10 may reduce the overall area of the mart 50 through the digital signage 200, a mart operator may provide a new type of mart, in which online advantages and offline advantages are combined, in a building having a small area at a district with a lot of floating population.

Further, since users, who have conveniently ridden in cars and purchased goods at marts, may make a goods purchase list through recognition of barcode images and QR code images of goods through the goods purchase apparatus 100 and goods corresponding to the good purchase list may be delivered to desired delivery places (for example, homes), the users may conveniently perform shopping during working hours or lunch breaks on weekdays rather than on weekends or at night.

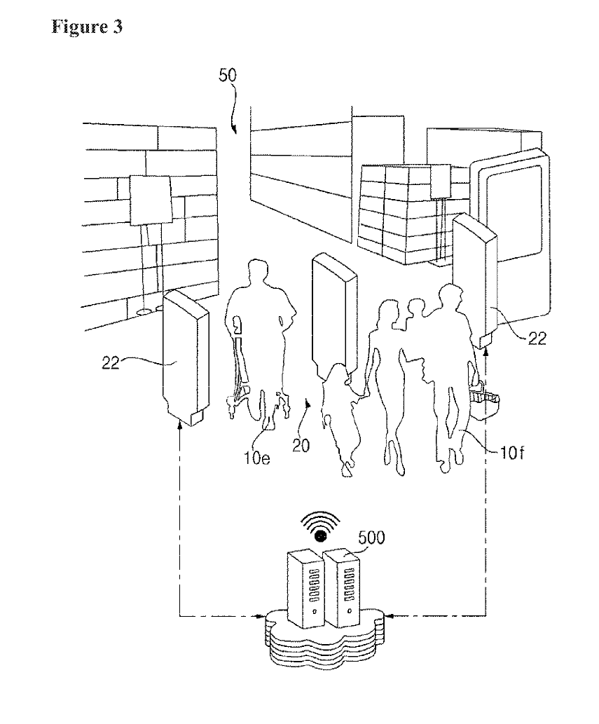

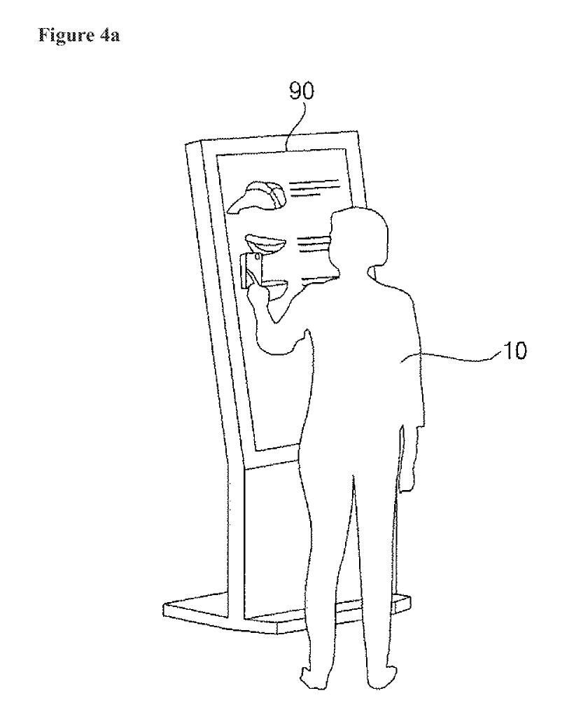

FIG. 3 is a view exemplarily illustrating use of the entrance zone of FIG. 1 by users.

FIG. 3 exemplarily illustrates that a first user 10f enters into the mart through the entrance zone 20 and a second user 10e exits the mart through the entrance zone 20.

As one example, if the first user 10f picks up one of a plurality of goods purchase apparatuses 100 arranged around the entrance zone 20 and scans his/her membership card or a barcode image in a mart related application in the mobile terminal 600 using the goods purchase apparatus 100, the goods purchase apparatus 100 may transmit the scanned image to the server 500 to perform user information authentication. Then, the server 500 may assign a unique ID corresponding to the first user 10f to the corresponding goods purchase apparatus 100 and thus distinguish the corresponding goods purchase apparatus 100 from other goods purchase apparatuses 100.

Otherwise, if the first user 10f picks up one of a plurality of goods purchase apparatuses 100 arranged around the entrance zone 20 and tags the goods purchase apparatus 100 with his/her membership card or mobile terminal 600, the goods purchase apparatus 100 may receive user information of the first user 10f through RFID or NFC communication and transmit the received user information to the server 500. Then, the server 500 may assign a unique ID corresponding to the first user 10f to the corresponding goods purchase apparatus 100 and thus distinguish the corresponding goods purchase apparatus 100 from other goods purchase apparatuses 100.

Further, if the first user 10f passes through the entrance zone 20 while holding the goods purchase apparatus 100, the entry authentication apparatus 22 located within the entrance zone 20 may receive the unique ID information assigned to the goods purchase apparatus 100 through communication with the goods purchase apparatus 100 and transmit the received unique ID information to the server 500. Thereby, the server 500 may recognize entry of the first user 10f into the mart.

As another example, if the first user 10f passes through the entrance zone 20 while holding user's membership card or mobile terminal 600, the entry authentication apparatus 22 located within the entrance zone 20 may receive the user information of the first user 10f through RFID or NFC communication with the user's membership card or mobile terminal 600 and transmit the received user information to the server 500. Thereby, the server 500 may recognize entry of the first user 10f into the mart.

If the second user 10e holding a goods purchase apparatus 100 exits the mart through the entrance zone 20, the server 500 may recognize exit of the second user 10e to the outside of the mart.

Otherwise, if the second user 10e holding the goods purchase apparatus 100 exits the mart through the entrance zone 20, the goods purchase apparatus 100 may transmit a unique ID to the entry authentication apparatus 22 and the entry authentication apparatus 22 may receive a goods purchase list of the second user 10e, stored in the server 500, from the server 500.

The entry authentication apparatus 22 may automatically perform payment for goods based on the received goods purchase list.

For example, the entry authentication apparatus 22 may select the user's membership card or mobile terminal 600 as a payment method and automatically perform payment if the second user 10e exits the mart through the entrance zone 20.

That is, automatic personal authentication related to a point of sales (POS) system may be performed and purchase or payment interlocking with the mobile terminal may be performed through the entrance zone 20.

If a user frequently using online shopping malls enters into the mart through the entrance zone 20, separate information specialized for the corresponding user may be provided to the user through the entry authentication apparatus 22.

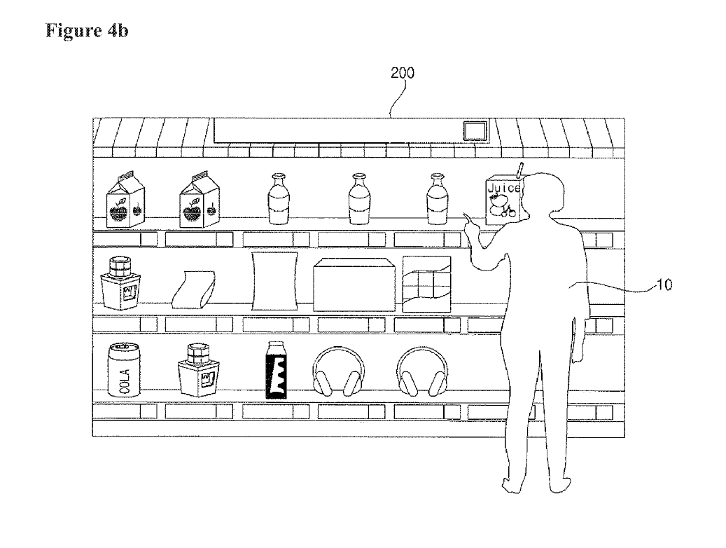

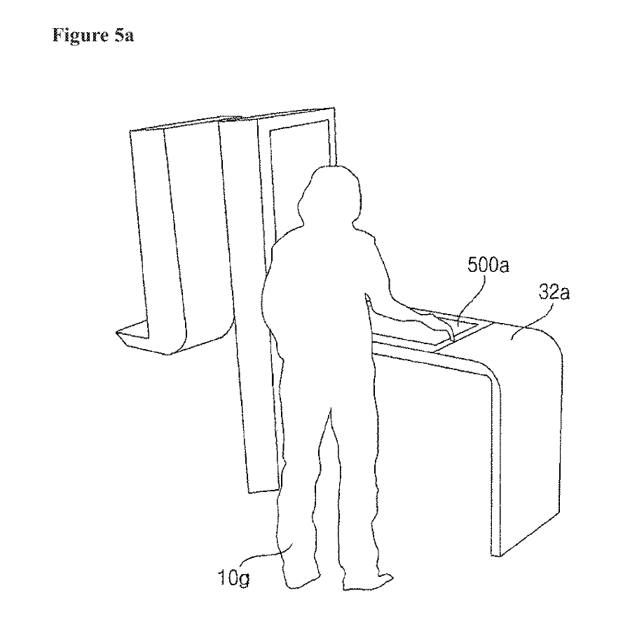

FIG. 4A is a view exemplarily illustrating the theme zone in the shopping zone of FIG. 1 and FIG. 4B is a view exemplarily illustrating the variety zone in the shopping zone of FIG. 1.

First, in the theme zone of FIG. 4A, goods display stands are divided into various packages according to brands or prices and various promotions, such as a customized package or a recommended package, may be carried out.

Goods display stands in which goods are displayed and information display units 90 displaying price information may be provided within the theme zone. The information display unit 90 may include barcode images and QR code images including price information.

The information display unit 90 may be implemented as a display device and a user may confirm information related to goods arranged in the theme zone by operation of the information display unit 90.

Further, in the variety zone of FIG. 4B, online mall goods information may be confirmed and customer information-based customized advertisement and promotion may be performed. In the variety zone, in addition to goods display stands, digital signages 200 in which online information, customer-based information, and promotion information are displayed may be provided.

The digital signage 200 is an image display device which may display various goods images and at least one of mart provided price information, online mall price information, similar goods information, customer-based recommended goods information and mart provided promotion information corresponding thereto.

Further, the digital signage 200 may display images of goods, which are not displayed in the goods display stand, together with various pieces of information. The digital signage 200 may provide images and various pieces of information of various goods and thus reduce the actual size of the goods display stand.

Since the overall area of the mart 50 may be reduced through such a digital signage 200, a mart operator may provide a new type of mart, in which online advantages and offline advantages are combined, in a building having a small area at a district with a lot of floating population.

Further, since users, who have conveniently ridden in cars and purchased goods at marts, may make a goods purchase list through recognition of barcode images and QR code images of goods and goods corresponding the goods purchase list may be delivered to homes, the users may conveniently perform shopping during working hours or lunch breaks on weekdays rather than on weekends or at night.

The digital signage 200 may include a transparent display. Thereby, various pieces of information including price information may be displayed on the transparent display under the condition that actual goods are displayed in a showcase.

Further, the digital signage 200 may include an image projection module. When a projected image is displayed on a screen through the image projection module, goods images and various pieces of information may be displayed even on a free-form surface.

The image projection module may output both visible light and infrared light and the goods purchase apparatus 100 may recognize infrared light so that corresponding goods may be added to a purchase list. Otherwise, the image projection module may recognize the position of the goods purchase apparatus 100 through infrared light, determine goods which a user desires to purchase based on the position, and transmits the determined goods information to the goods purchase apparatus 100.

The digital signage 200 may display barcode images and QR code images of goods together with goods images. Therefore, if the image capture unit 120 (in FIG. 10) of the goods purchase apparatus 100 recognizes a barcode image or a QR code image, corresponding goods may be added to the purchase list.

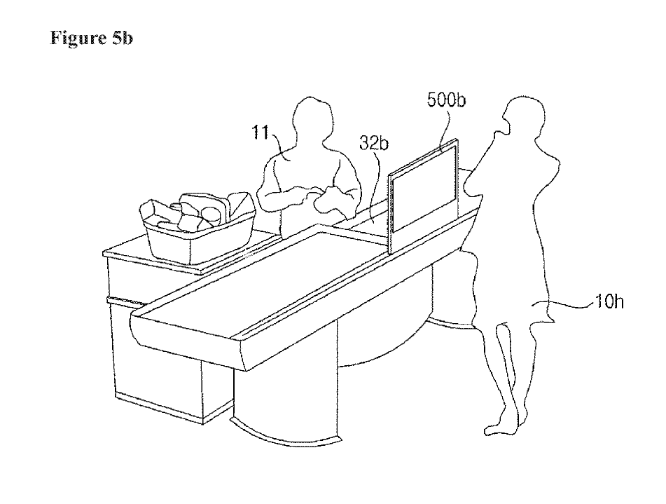

FIG. 5A is a view exemplarily illustrating a self checkout counter in the counter zone of FIG. 1 and FIG. 5B is a view exemplarily illustrating a helper counter in the counter zone of FIG. 1.

A self checkout counter 32a of FIG. 5A is one example of the calculation apparatus 32 of FIG. 1 and may include a touch type monitor 500a which is horizontally disposed.

For example, if tagging of the monitor 500a with the goods purchase apparatus 100 held by a user 10g is performed, the self checkout counter 32a may recognize the user 10g holding the goods purchase apparatus 100 and receive a list of goods purchased by the user 10g from the server 500, the user's mobile terminal 600, or the goods purchase apparatus 100.

Then, the monitor 500a may display the list of goods purchased by the user 10g. In addition to the goods list, the monitor 500a may further display a purchase decision/cancellation item and a delivery/direct carriage item.

Further, the user 10g may perform purchase decision/cancellation or delivery/direct carriage in the goods list displayed on the monitor 500a through touch input.

A user's membership card or mobile terminal may be used as a payment means, and an authentication procedure for identifying the user 10g may be further required during payment.

In accordance with the method of using the self checkout counter 32a of FIG. 5A, sales promotion may be carried out due to reduction in a waiting time during payment and exposure of similar product advertisements.

A helper counter 32b of FIG. 5B is another example of the calculation apparatus 32 of FIG. 1 and may include a touch type monitor 500b which is vertically disposed. The helper counter 32b requires a separate cashier 11.

If the cashier 11 or a user 10h performs tagging of the monitor 500b with the goods purchase apparatus 100, the helper counter 32b may recognize the user 10h of the goods purchase apparatus 100 and receive a list of goods purchased by the user 10h from the server 500, the user's mobile terminal 600, or the goods purchase apparatus 100.

Then, the monitor 500b may display the list of goods purchased by the user 10g. In addition to the goods list, the monitor 500b may further display a purchase decision/cancellation item and a delivery/direct carriage item.

Further, the user 10h may perform purchase decision/cancellation or delivery/direct carriage in the goods list displayed on the monitor 500a through touch input.

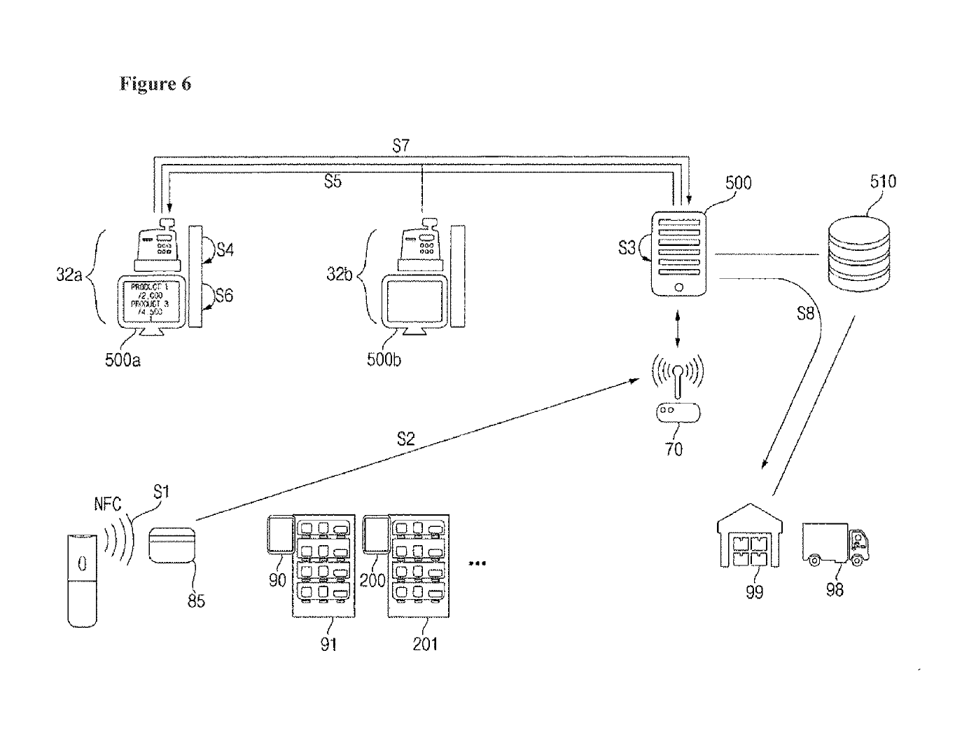

FIG. 6 is a view illustrating a goods purchase and delivery flow.

With reference to FIG. 6, if tagging of the goods purchase apparatus 100 with a user's membership card 85 is performed (Operation S1), the goods purchase apparatus 100 receives user information from the membership card 85 and transmits the user information to the mart server 500 through the AP apparatus 700 (Operation S2).

Then, the server 500 performs matching between user information stored in a storage unit (not shown) and the received user information (Operation S3). Thereafter, the server 500 performs user authentication. Thereafter, the server 500 may assign ID information to the goods purchase apparatus 100 and transmit the ID information to the goods purchase apparatus 100.

If a user enters into the shopping zone and scans information of goods desired to purchase among goods in the mart using the goods purchase apparatus 100, the goods desired to purchase are added and thus, a goods purchase list is made. The made goods purchase list is transmitted to the server 500 through the goods purchase apparatus 100, and the server 500 stores the goods purchase list.

If the user enters into the counter zone and tags the monitor 500a of the purchased goods calculation apparatus 32a disposed on the counter with the goods purchase apparatus 100 or tags the monitor 500a of the purchased goods calculation apparatus 32a disposed on the counter with the user's membership card 85 (Operation S4), the monitor 500a of the purchased goods calculation apparatus 32a disposed on the counter requests the server 500 to transmit the goods purchase list of the corresponding user and the server 500 transmits the goods purchase list to the monitor 500a of the purchased goods calculation apparatus 32a disposed on the counter (Operation S5). Then, the monitor 500a of the purchased goods calculation apparatus 32a disposed on the counter displays the received goods purchase list and performs a payment procedure using the received goods purchase list and the user's membership card 85.

After payment has been completed, the monitor 500a of the purchased goods calculation apparatus 32a disposed on the counter requests the server 500 to deliver purchased the goods (Operation S7) and the server 500 transmits a request for delivery of the purchased goods to a head office server 510.

The head office server 510 transmits the request for delivery of purchased goods to a warehouse 99 (Operation S8) and the warehouse 99 loads the purchased goods on a delivery vehicle 99 and performs delivery.

Thereby, the user may conveniently shop goods and receive the goods.

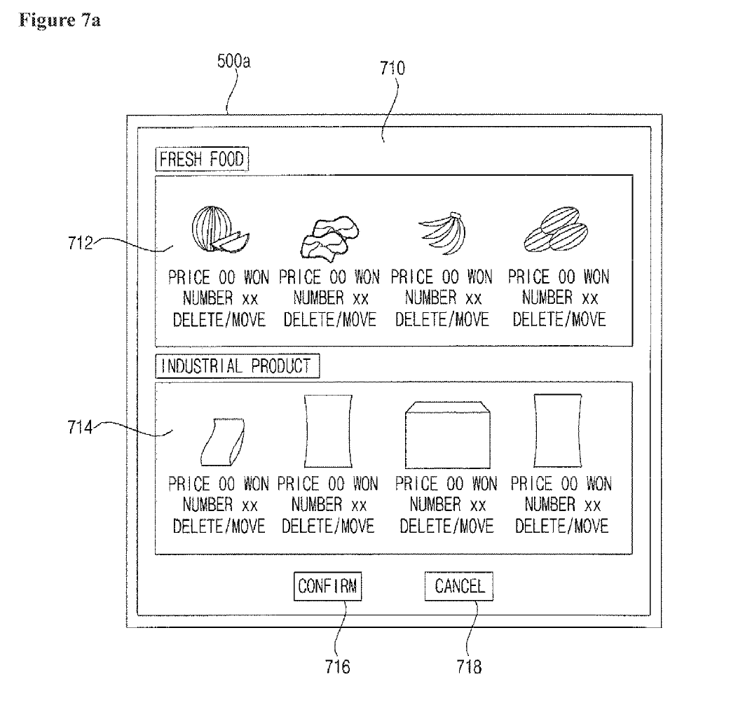

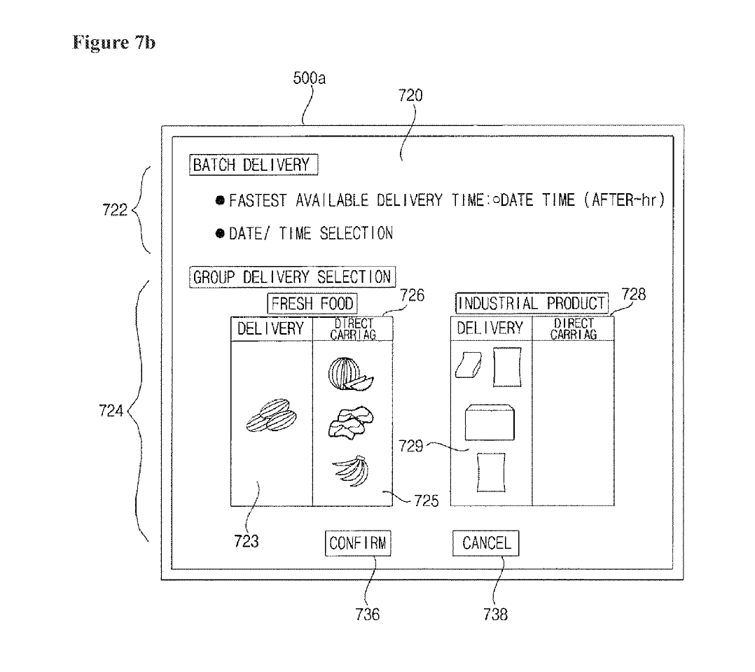

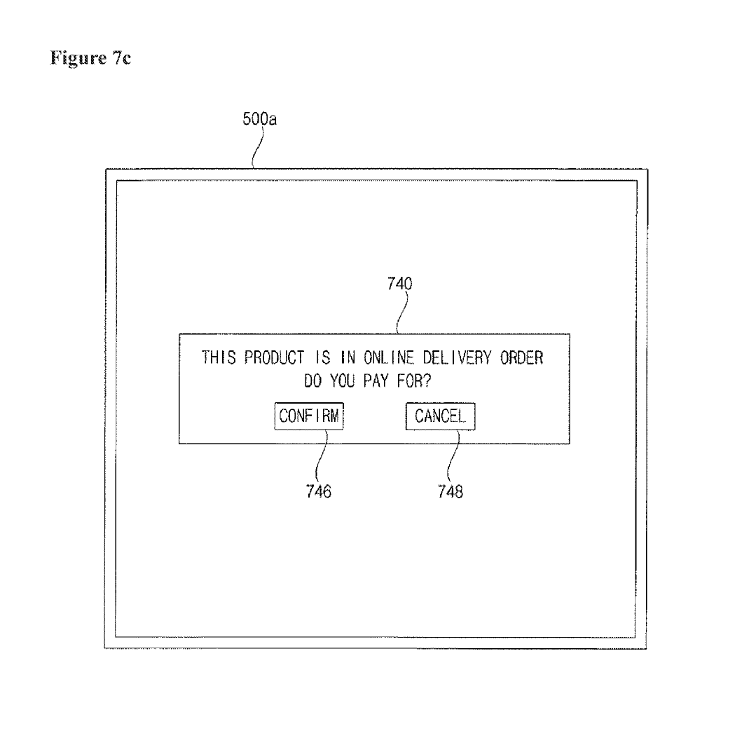

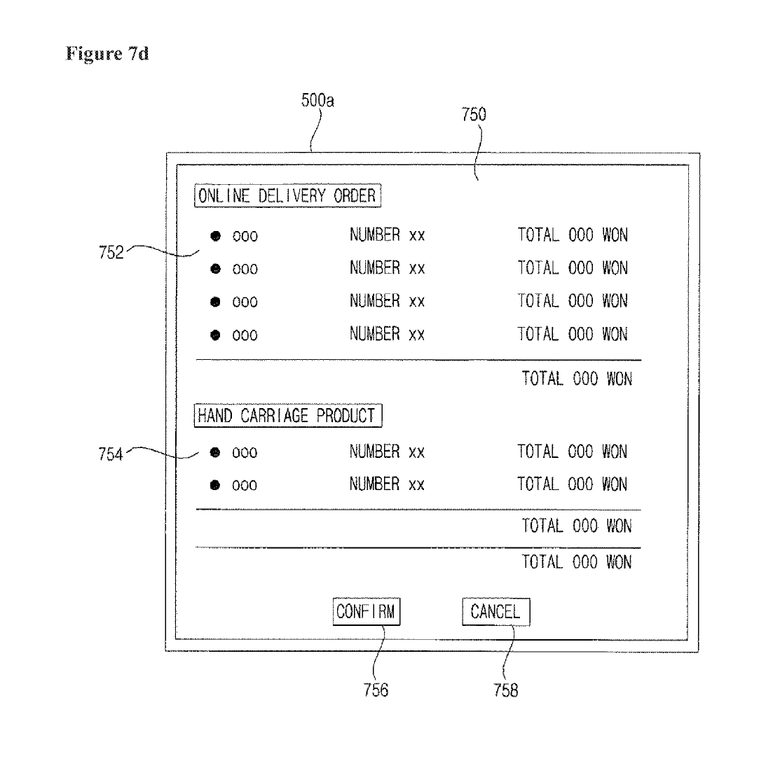

FIGS. 7A and 7B are views illustrating division of purchased goods into goods to be delivered and goods to be directly carried through a goods purchase list, when purchase of the goods has been completed.

With reference to FIG. 7A, if a user enters into the counter zone and tags the monitor 500a of the purchased goods calculation apparatus 32a disposed on the counter with the goods purchase apparatus 100 or tags the monitor 500a arranged in the counter with the user's membership card 85, the monitor 500a of the purchased goods calculation apparatus 32a located in the counter zone receives a user's goods purchase list 710 from the server 500 and displays the received goods purchase list 710.

In the goods purchase list 710, purchased goods may be aligned in order of purchase or aligned according to kinds.

FIGS. 7A and 7B exemplarily illustrate that the goods purchase list 710 is divided into a fresh food list 712 and an industrial product list 714. However, there may be various examples of division of the goods purchase list 710.

The goods purchase list 710 may include images displaying goods items, and price information, and purchase number information of respective goods. Further, an object indicating whether or not each goods are purchased or deleted may be displayed for each goods item.

In addition to the fresh food list 712 and the industrial product list 714, the goods purchase list 710 may further include a confirmation item 716 and a cancellation item 718.

With reference to FIG. 7A, products in the goods purchase list 710 are displayed as thumbnail images so as to be easily visible and thus, a user may intuitively recognize purchased goods.

Further, categories may be classified according to kinds/numbers of products in the goods purchase list 710 or classified according to package dates/expiration dates and thus, user convenience may be increased.

Through the confirmation item 716 and the cancellation item 718, a product input by mistake may be canceled, or a product may be canceled when the user changes their mind.

FIG. 7B exemplarily illustrates that a delivery method set image 720 is displayed on the monitor 500a after selection of the confirmation item 716 of FIG. 7A.

In FIG. 7B, in the delivery method set image 720, a batch delivery item 722 and a group delivery selection item 724 are displayed.

The batch delivery item 722 may include an available delivery time item and a delivery date/time selection item.

The group delivery selection item 724 may include a fresh food item 726 and an industrial product item 728, and the fresh food item 726 and the industrial product item 728 may respectively include delivery items 723 and 729 and direct carriage items 725 and 728.

Respective goods images in the delivery items 723 and 729 and the direct carriage items 725 and 728 are first displayed as defaults and then may be moved to desired items by user touch input.

Thereby, user convenience may be increased.

The group delivery selection item 724 may further include an available delivery time item and a delivery date/time selection item.

Delivery times for respective categories may be set differently. The delivery time for the fresh food item 726 and the delivery time for the industrial product item 728 may be set differently.

The delivery method set image 720 may further include a confirmation item 736 and a cancellation item 738, in addition to the batch delivery item 722 and the group delivery selection item 724.

With reference to FIG. 7B, a user may confirm categories and amend the delivery items and the direct carriage items and thus, user convenience may be increased.

FIG. 7C exemplarily illustrates an online order payment confirmation image 740 displayed on the monitor 500a, after selection of the confirmation item 736 of FIG. 7B.

If, in addition to the goods purchase list of goods purchased in the mart, there is a shopping list of goods shopped in an online shopping mall operated by the operator of the corresponding mart, the monitor 500a of the purchased goods calculation apparatus 32a disposed on the counter may display the online order payment confirmation image 740 indicating whether or not goods shopped in the online shopping mall by the corresponding user have been paid for.

The online order payment confirmation image 740 may include a confirmation item 746 and a cancellation item 748.

FIG. 7D exemplarily illustrates a final payment image 750 displayed on the monitor 500a, after selection of the confirmation item 746 of FIG. 7C.

The final payment image 750 may include an online delivery list 752 and a hand carriage list 754.

The final payment image 750 may further include a confirmation item 756 and a cancellation item 758. When the confirmation item 756 is selected, payment information, online delivery information and hand carried product information may be transmitted to the server 500.

Thereby, the server 500 may perform processing of payment and processing of online delivery. If a user puts goods to be directly carried into a cart, the user may directly carry the goods by passing through the entrance zone.

However, if the user does not put goods to be directly carried into the cart, an employee in the mart 50 may bring the goods to be directly carried around the entrance zone. Then, the user may pick up the corresponding goods.

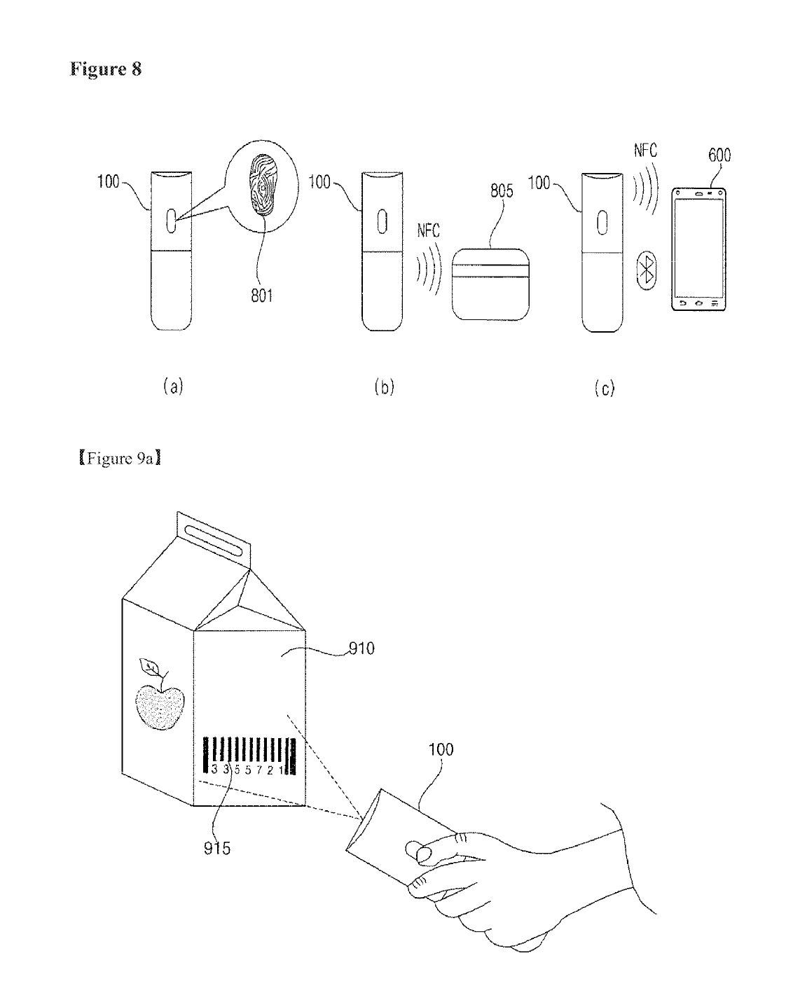

FIGS. 8(a) to 8(c) are views exemplarily illustrating various user authentication methods using the goods purchase apparatus.

First, FIG. 8(a) exemplarily illustrates that the image capture unit 120 (in FIG. 10) of the goods purchase apparatus 100 recognizes a user's fingerprint. If a user's finger touches the image capture unit 120 (in FIG. 10), the image capture unit 120 (in FIG. 10) may scan a user's fingerprint, transmit the scanned fingerprint image to the server 500, and receive authenticated user information from the server 500. Thereby, user authentication may be completed.

Next, FIG. 8(b) exemplarily illustrates that NFC communication is performed by tagging the goods purchase apparatus 100 with the membership card 85 and thus, user information stored in the membership card 85 is transmitted to the goods purchase apparatus 100. The goods purchase apparatus 100 may transmit the received user information to the server 500 and receive matching user information from the server 500. Thereby, user authentication may be completed.

Further, FIG. 8(c) exemplarily illustrates that NFC communication is performed by tagging the goods purchase apparatus 100 with the mobile terminal 600 and thus, user information stored in the mobile terminal 600 is transmitted to the goods purchase apparatus 100. Thereby, user authentication may be completed.

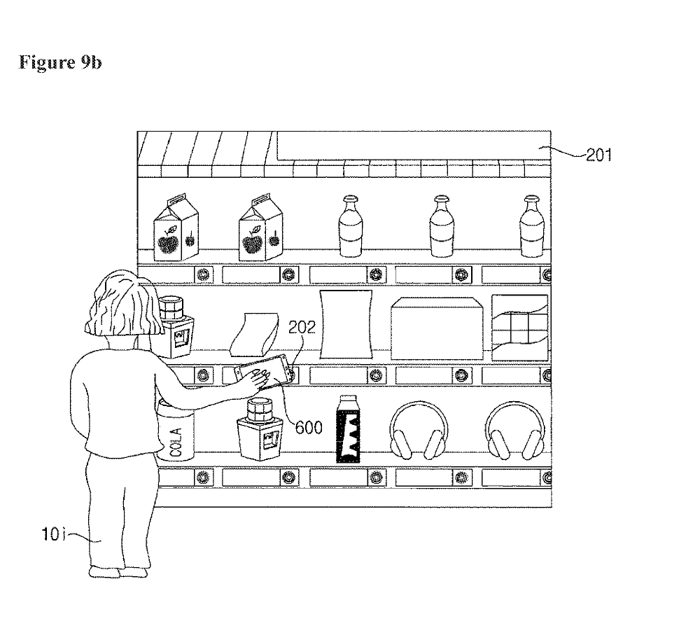

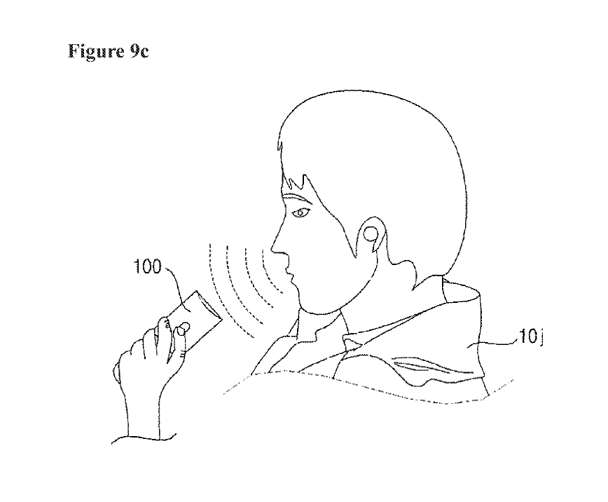

FIGS. 9A to 9C are views exemplarily illustrating various examples of purchase of goods using the goods purchase apparatus.

First, FIG. 9A exemplarily illustrates that the goods purchase apparatus 100 recognizes a barcode image 915 attached to a product 910. The goods purchase apparatus 100 may recognize information of the product 910 through the image capture unit 120 and transmit purchase information of the product 910 to the server 500.

Further, FIG. 9B exemplarily illustrates that the mobile terminal 600 of a user 10i scans an information display unit 202 displaying goods information on a goods display stand 102 for purchasing goods.

A camera of the mobile terminal 600 may acquire an image displayed on the information display unit 202 and the mobile terminal 600 may recognize goods information based on the acquired image and transmit purchase information of a product to the server 500.

The image displayed on the information display unit 202 may include a barcode image or a QR code image.

Further, FIG. 9C exemplarily illustrates that a user 10j outputs a voice to the goods purchase apparatus 100. The goods purchase apparatus 100 including an audio input unit may perform voice signal processing of the user's voice and process order information according to the user's voice.

For example, number information of goods desired to purchase, cancellation information of the goods, and staff calling information may be processed based on the user's voice.

FIG. 10 is one exemplary block diagram illustrating the inside of the goods purchase apparatus of FIG. 1.

With reference to FIG. 10, the goods purchase apparatus 100 may include an image capture unit 120, a sensor unit 130, a communication unit 150 for communication with other external devices, a memory 140, an audio input unit 185, an audio output unit 187, and a power supply unit 190. The image capture unit 120 may scan a barcode image or a QR code image and recognize the scanned image so as to purchase goods.

For this purpose, the image capture unit 120 may at least include an image sensor. The image capture unit 120 may further include an image processor. For example, the image capture unit 120 may include an infrared camera.

The recognized image may be transmitted to a controller 170 and the controller 170 may extract goods information from the barcode image or the QR code image. Further, the controller 170 may generate goods purchase information based on the extracted goods information. The generated goods purchase information may be transmitted to the external server 500, mobile terminal 600, or digital signage 200 through the communication unit 150.

The sensor unit 130 may include sensors to sense operation of the goods purchase apparatus 100.

For example, the sensor unit 130 may include an acceleration sensor, a gyro sensor, a gravity sensor, etc.

The memory 140 may store a program for processing or control through the controller 170 and perform a function to temporarily store input or output data (for example, a moving image, a still image, etc.).

The communication unit 150 may at least include a wireless communication unit (not shown) for wireless communication.

The communication unit 150 may include the wireless communication unit (not shown) and a near field communication unit (not shown) for wireless communication with the server 500, the AP apparatus 70, the mobile terminal 600, or the digital signage 200.

For example, the wireless communication unit (not shown) may perform WiFi communication. The communication unit 150 may perform wireless data communication with the server 500, the AP apparatus 70, the mobile terminal 600, or the digital signage 200 through the wireless communication unit (not shown).

As one example, the communication unit 150 may transmit goods purchase information based on a barcode image or a QR code image, scanned through the image capture unit 120, to the external server 500, mobile terminal 600, or digital signage 200.

As another example, the communication unit 150 may transmit goods purchase number information and goods purchase cancellation information based on a user's voice, input through the audio input unit 185, to the external server 500, mobile terminal 600, or digital signage 200. The communication unit 150 may include the near field communication unit (not shown) for near field communication, such as RFID communication or NFC communication.

If tagging of the goods purchase apparatus 100 with a user's membership card is performed, the communication unit 150 may receive user information stored in the membership card by NFC communication through the near field communication unit (not shown).

Further, the communication unit 150 may transmit the received user information to the external server 500, the mobile terminal 600, or the digital signage 200 by WiFi communication through the wireless communication unit (not shown).

That is, the communication unit 150 may use different communication schemes during reception of the user information from the user's membership card and during transmission of the user information to the server 500.

The controller 170 may perform overall control of the goods purchase apparatus 100. In more detail, the controller 170 may control operation of the respective units of the goods purchase apparatus 100.

For example, if user information is received by tagging with the membership card, the controller 170 may control the communication unit 150 so as to transmit the user information to the server 500.

If a barcode image or a QR code image including a goods image or goods information is scanned through the image capture unit 120 and thus, the scanned image is acquired, the controller 170 may extract various pieces of information from the scanned image. Further, the controller 170 may generate purchase decision information of the corresponding goods information and transmit the generated purchase decision information to the server 500. Further, the controller 170 may transmit ID information together with transmission of the purchase decision information.

If a user or the goods purchase apparatus 100 held by the user passed through the entry authentication apparatus located in the entrance zone 20 in the mart, the controller 170 may transmit user information or ID information to the server 500.

The controller 170 may recognize a user's voice input through the audio input unit 185, extract goods purchase number information and goods purchase cancellation information through recognition of the voice, and transmit the extracted goods purchase number information and goods purchase cancellation information to the external server 500, the mobile terminal 600, or the digital signage 200.

The audio input unit 185 may receive a user's voice. For this purpose, the audio input unit 185 may include a microphone. The audio input unit 185 may convert the received voice into an electrical signal and transmit the electrical signal to the controller 170.

The audio output unit 187 converts the electrical signal from the controller 170 into an audio signal and outputs the audio signal. For this purpose, the audio output unit 187 may include a speaker.

The power supply unit 190 may receive external power or internal power under control of the controller 170 and supply power required to operate respective elements of the goods purchase apparatus 100. For example, the power supply unit 190 may include a battery and supply power form the battery to the inside of the goods purchase apparatus 100.

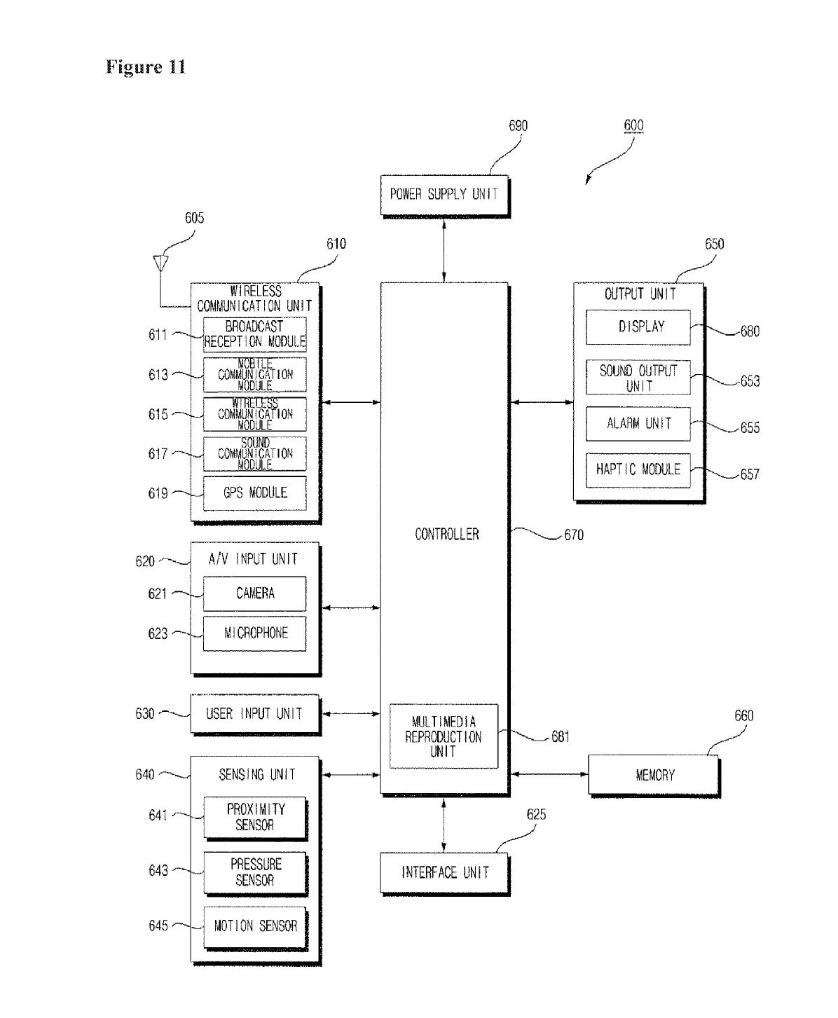

FIG. 11 is one exemplary block diagram illustrating the inside of the mobile terminal of FIG. 1. With reference to FIG. 11, the mobile terminal 600 may include a wireless communication unit 610, an audio/video (A/V) input unit 620, a user input unit 630, a sensing unit 640, an output unit 650, a memory 660, an interface unit 625, a controller 670, and a power supply unit 690.

The wireless communication unit 610 may include a broadcast reception module 611, a mobile communication module 613, a wireless Internet module 615, a sound communication unit 617, and a global positioning system (GPS) module 619.

The broadcast reception module 611 may receive at least one of a broadcast signal and broadcast-related information from an external broadcast management server through a broadcast channel.

The broadcast signal and broadcast-related information received through the broadcast reception module 611 may be stored in the memory 660.

The mobile communication module 613 receives/transmits a wireless signal from/to at least one of a base station, an external terminal, and an external server in a mobile communication network. Here, the wireless signal may include a voice call signal, a video communication call signal, or various types of data according to text/multimedia message reception/transmission.

The wireless Internet module 615 is a module for wireless Internet connection, and may be installed at the inside or outside of the mobile terminal 600.

The sound communication unit 617 may perform sound communication. The sound communication unit 617 may add designated information data to audio data, which will be output, in a sound communication mode and thus output a sound. Further, the sound communication unit 617 may extract designated information data from a sound, received from the outside, in the sound communication mode.

The GPS module 619 may receive position information from a plurality of GPS artificial satellites.

The A/V input unit 620 serves to input an audio signal or a video signal, and may include a camera 621 and a microphone 623.

The user input unit 630 generates key input data input by a user to control operation of the mobile terminal 600. For this purpose, the user input unit 630 may include a keypad, a dome switch, and a touch pad (hydrostatic/capacitive). Particularly, if the touch pad and a display 680 form a mutually layered structure, they may be referred to as a touchscreen.

The sensing unit 640 may sense the current state of the mobile terminal 600, such as the open and closed state of the mobile terminal 600, the position of the mobile terminal 600, and whether or not a user contacts the mobile terminal 600, and generate a sensing signal to control operation of the mobile terminal 600.

The sensing unit 640 may include a proximity sensor 641, a pressure sensor 643, and a motion sensor 645. The motion sensor 645 may sense the movement or position of the mobile terminal 600 using an acceleration sensor, a gyro sensor, or a gravity sensor. Particularly, the gyro sensor serves to measure an angular velocity, and may sense a direction (angle) rotated from a reference direction.

The output unit 650 may include the display 680, an audio output unit 653, an alarm unit 655, and a haptic module 657.

The display 680 displays and outputs information processed by the mobile terminal 600.

If the touch pad and the display 680 form a mutually layered structure and thus form a touchscreen, as described above, the display 680 may be used as an input device to which information may be input by user touch, as well as an output device.

The audio output unit 653 outputs audio data received from the wireless communication unit 610 or stored in the memory 660. The audio output unit 653 may include a speaker or a buzzer.

The alarm unit 655 outputs a signal informing of generation of an event. For example, the alarm unit 655 may output a signal as vibration.

The haptic module 657 generates various haptic effects which a user may feel. As a representative example of the haptic effect generated by the haptic module 657, there is a vibration effect.

The memory 660 may store a program for processing or control through the controller 670 or perform a function of temporarily storing input or output data (for example, a phone-book, a message, a still image, a moving image, etc.).

The interface unit 625 may serve as an interface with all external devices connected to the mobile terminal 600. The interface unit 625 may receive data or power transmitted or supplied from these external devices, transmit the received data or power to the respective elements of the mobile terminal 600, and transmit data within the mobile terminal 600 to the external devices.

The controller 670 controls operations of the respective units of the mobile terminal 600 and thus controls the overall operation of the mobile terminal 600. For example, the controller 670 may perform control and processing related to voice phone call, data communication, and video phone call. Further, the controller 670 may include a multimedia reproduction module 681 to reproduce multimedia. The multimedia reproduction module 681 may be provided as hardware in the controller or be provided as software separately from the controller 670.

The power supply unit 690 receives external power or internal power under control of the controller 670 and supplies power required to operate the respective elements of the mobile terminal 600.

The block diagram of the mobile terminal 600 shown in FIG. 11 is a block diagram of the mobile terminal 600 in accordance with one embodiment of the present invention. The respective elements in the block diagram may be unified, added, or omitted according to specification of a mobile terminal 600 which is actually implemented. That is, as needed, two or more elements may be unified into one element, or one element may be divided into two or more elements.

Further, the functions performed by the respective blocks have been made only for a better understanding of the present invention, and detailed operations or devices thereof do not limit the scope and spirit of the invention.

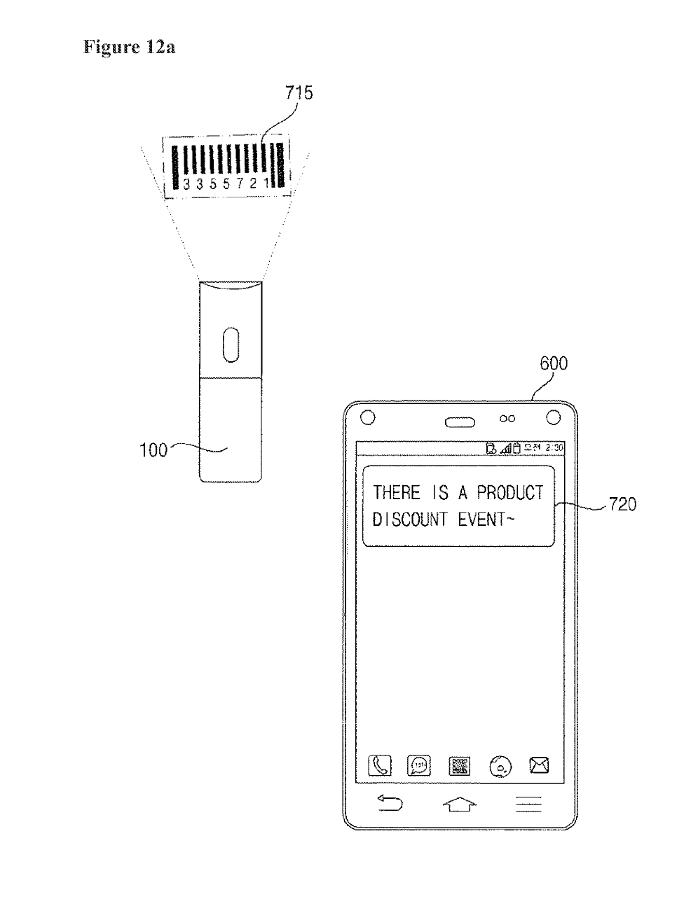

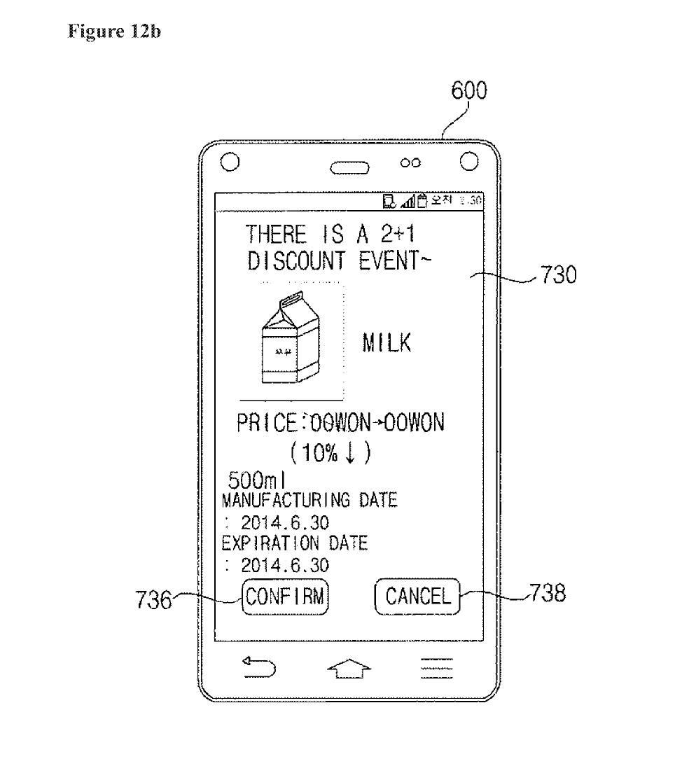

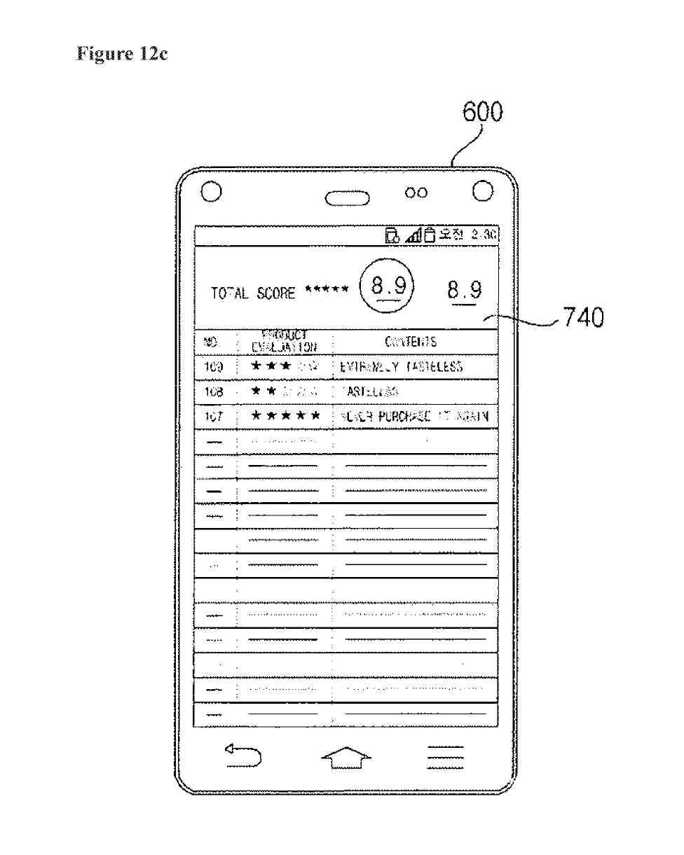

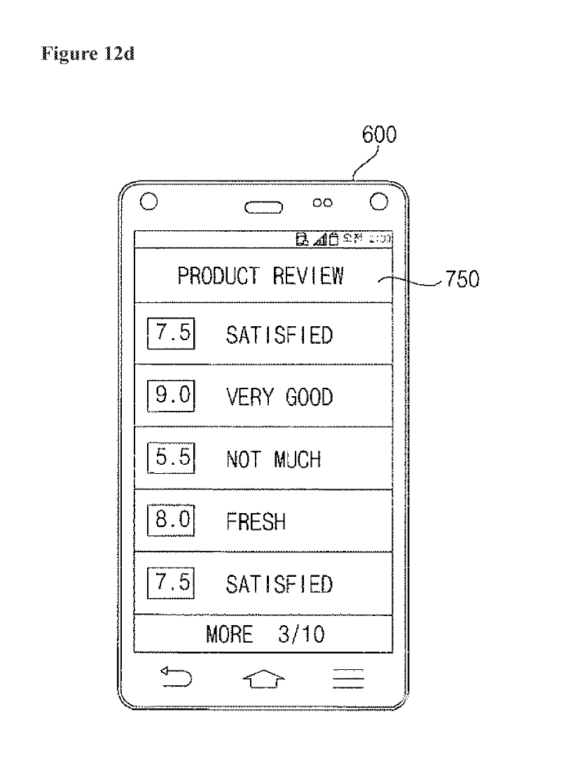

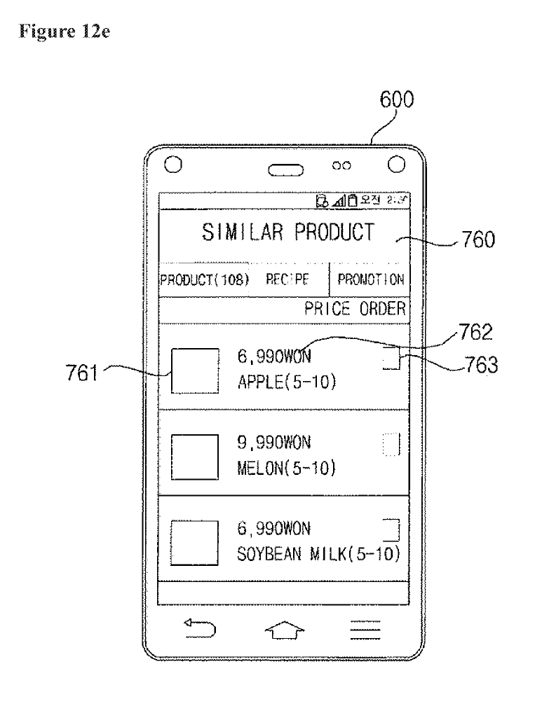

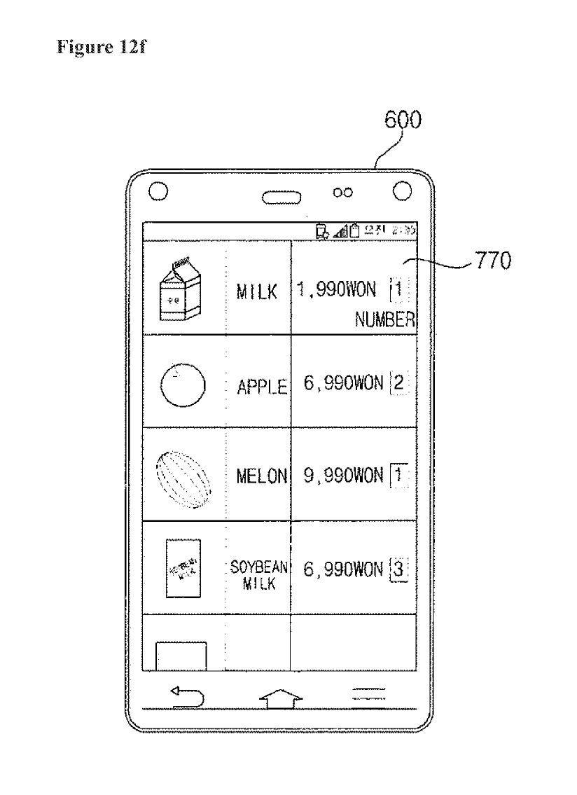

FIGS. 12A to 19 are views illustrating a goods purchase method.

First, FIG. 12A exemplarily illustrates that a barcode image 715 indicating goods information is scanned using the goods purchase apparatus 100.

The image capture unit 120 of the goods purchase apparatus 100 may scan the barcode image 715 and the controller 170 may extract goods information from the barcode image 715.

In a state in which the user's mobile terminal 600 and the goods purchase apparatus 100 are paired, the extracted goods information may be transmitted to the mobile terminal 600 and the mobile terminal 600 may transmit goods information to the server 500. Further, the mobile terminal 600 may receive information related to the corresponding goods from the server 500.

Further, as exemplarily shown in FIG. 12A, the mobile terminal 600 may display information 720 related to the goods through the display 680. FIG. 12A exemplarily illustrates that the discount information 720 related to the corresponding goods is received and displayed. Here, the discount information 720 may be displayed as a pop-up.

The above-described transmission and reception of goods information to and from the server 500 may be performed under the condition that an application related to the mart is executed in the mobile terminal 600.

The discount information 720 of FIG. 12A may be information provided from the server 500 without scan of a goods or barcode image.

For example, the server 500 may provide the discount information 720, as customized information according to a user's shopping history, to the mobile terminal 600.

Otherwise, if the user accesses the corresponding goods according to movement in the mart, the server 500 may automatically provide the discount information 720 to the mobile terminal 600 in consideration of the position of the user.

FIG. 12B exemplarily illustrates that a detailed discount information image is displayed.

If there is touch input to the discount information 720 of FIG. 12A, a detailed discount information image 730 may be displayed on the display 680 of the mobile terminal 600, as exemplarily shown in FIG. 12B.

The detailed discount information image 730 may include discount information, price information, manufacture information, expiration date information, etc. The detailed discount information image 730 may further include a cancellation item 736 and a purchase item 738.

Further, the detailed discount information image 730 may be directly displayed regardless of the discount information 720 of FIG. 12A.

For example, the server 500 may provide the detailed discount information image 730, as customized information according to a user's shopping history, to the mobile terminal 600.

Otherwise, if the user accesses the corresponding goods according to movement in the mart, the server 500 may automatically provide the detailed discount information image 730 to the mobile terminal 600 in consideration of the position of the user.

Next, FIGS. 12C and 12D exemplarily illustrate that evaluation information of goods is displayed.

If there is touch input to the discount information 720 of FIG. 12A or there is touch input to the detailed discount information image 730 of FIG. 12B, evaluation information 740 or 750 of goods may be displayed on the display 680 of the mobile terminal 600, as exemplarily shown in FIG. 12C or 12D. Thereby, the user may refer to the evaluation information 740 or 750 when the user purchases the goods.

FIG. 12C exemplarily illustrates evaluation contents, number of stars, and total score of goods as the evaluation information 740 of the goods.

On the other hand, FIG. 12D exemplarily illustrates evaluation contents and evaluation scores of goods as the evaluation information 750 of the goods.

Next, FIG. 12E exemplarily illustrates that information regarding similar goods to goods desired to purchase is displayed.

If there is touch input to the discount information 720 of FIG. 12A, there is touch input to the detailed discount information image 730 of FIG. 12B, or there is input of similar goods information view under the condition information regarding goods is displayed, information 760 regarding similar goods to goods desired to purchase may be displayed on the display 680 of the mobile terminal 600, as exemplarily shown in FIG. 12E. Thereby, the user may refer to the similar goods information 760 when the user purchases the goods.

FIG. 12E exemplarily illustrates that images 761 and price information 762 of similar goods are displayed and further, check boxes 763 are displayed.

The server 500 or the mobile terminal 600 may make a goods purchase list by selection of goods purchased during shopping, and such a goods purchase list may be transmitted to the calculation apparatus 32 in the counter zone when shopping has been completed.

FIG. 12F exemplarily illustrates one example of a goods purchase list.

A goods purchase list 770 of FIG. 12F includes thumbnail images, names, price information, and number information of goods. Such a goods purchase list 770 may be displayed on a user's mobile terminal 600 for user convenience.

For example, if the user executes an application related to the mart and selects a goods purchase list item during shopping, the goods purchase list 770 of FIG. 12F may be displayed.

In more detail, when the goods purchase list item is selected, the mobile terminal 600 may request the server 500 to transmit the goods purchase list 770 and the server 500, in response to such a request, may transmit the goods purchase list 770 made up to the request time to the mobile terminal 600.

Otherwise, the goods purchase list 770 may be made in the mobile terminal 600 pairing with the goods purchase apparatus 100.

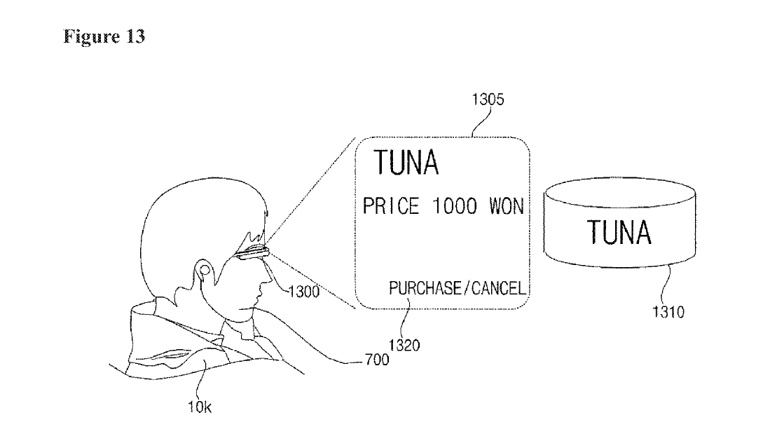

FIG. 13 exemplarily illustrates that information regarding goods is displayed through glasses which may display information.

If a user looks at specific goods 1310 while wearing glasses 1300 which may display information, the glasses 1300 may receive price information 1305 from the server 500 and display the price information 1305 at one region.

Here, the glasses 1300 may further display purchase/cancellation item 1320.

Purchase/cancellation may be determined by inputting a user's voice. In this case, the glasses 1300 may be operated as a goods purchase apparatus 100.

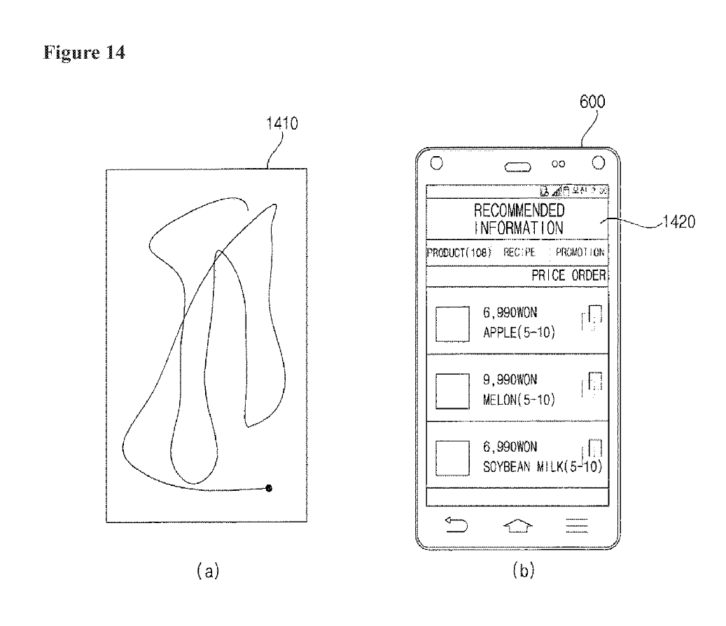

FIGS. 14(a) and 14(b) exemplarily illustrate display recommended information according to a user's moving path in a mart.

FIG. 14(a) exemplarily illustrates user's moving path information 1410 in a mart.

If a user carries a goods purchase apparatus 100 under the condition that a plurality of AP apparatuses 70 is installed in a mart 50, the good purchase apparatus 100 may perform wireless communication using the optimum AP apparatus 70 during movement. The server 500 may estimate a user's moving path using information of the AP apparatuses 70 changed whenever the user moves.

That is, the server 500 may generate the moving path information 1410 of FIG. 14(a).

FIG. 14(b) exemplarily illustrates display of goods recommended information 1420 on the display 680 of the mobile terminal 600 in consideration of the user's moving path in the mart 50.

FIG. 14(b) exemplarily illustrates display of images and price information of recommended goods as the recommended information 1420.

The server 500 may transmit the proper goods recommended information 1420 corresponding to the position information of the user to the mobile terminal 600.

For example, if the user is located adjacent to a first goods display stand, the server 500 may provide recommended information regarding some of goods displayed on the first display stand, particularly, goods in which the user is interested, to the mobile terminal 600. Thereby, the user may conveniently shop with reference to the recommended information.

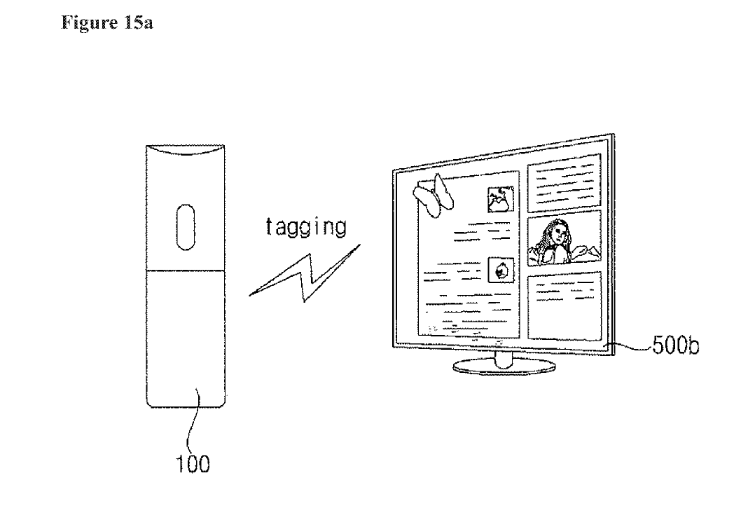

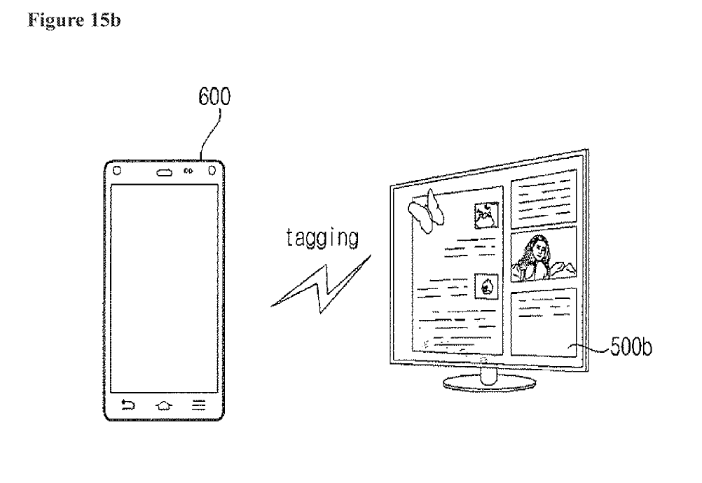

FIGS. 15A and 15B exemplarily illustrate payment using a goods purchase apparatus or a mobile terminal.

First, FIG. 15A exemplarily illustrates tagging of the monitor 500b of the purchased goods calculation apparatus 32b arranged on the counter with the goods purchase apparatus 100.

Further, FIG. 15B exemplarily illustrates tagging of the monitor 500b of the purchased goods calculation apparatus 32b arranged on the counter with the mobile terminal 600.

If tagging of the monitor 500b of the purchased goods calculation apparatus 32b with the goods purchase apparatus 100 or the mobile terminal 600 is performed, the monitor 500b of the purchased goods calculation apparatus 32b arranged on the counter requests the server 500 to transmit a goods purchase list of a corresponding user and the server 500 transmits the goods purchase list to the monitor 500b of the purchased goods calculation apparatus 32b arranged on the counter. Further, the monitor 500b of the purchased goods calculation apparatus 32b arranged on the counter displays the received goods purchase list and performs a payment procedure using the received goods purchase list and a user's membership card 85.

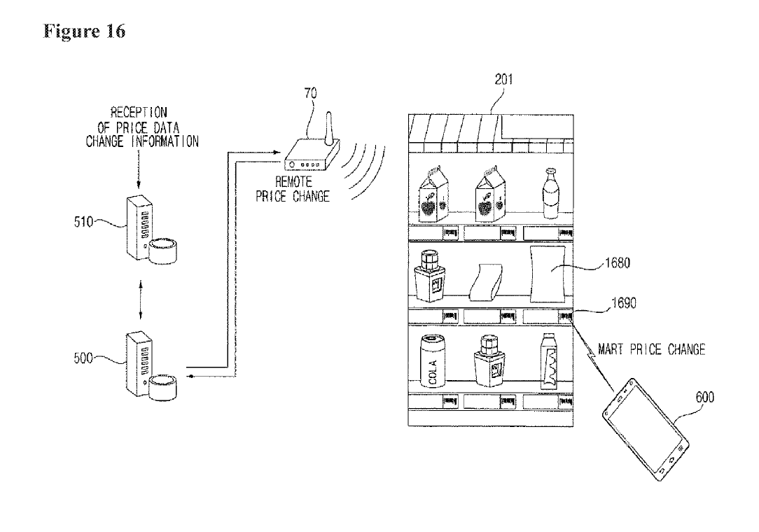

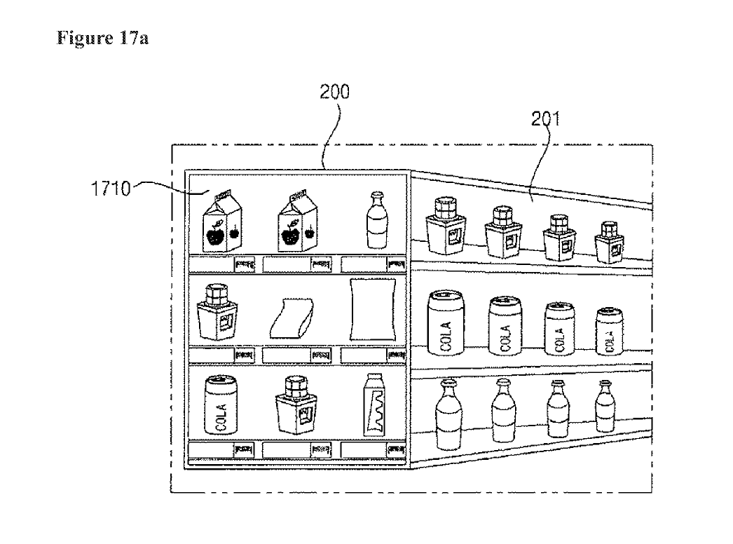

FIG. 16 exemplarily illustrates change of price information of goods remotely.

With reference to FIG. 16, if price data change information is input to a mart management server 510, the price data change information is transmitted to an ESL server 500. The ESL server 500 transmits the price data change information to the AP apparatus 70 and the AP apparatus 70 changes price information in an information display unit 1690 corresponding specific goods 1680 in a goods display stand 201. The information display unit 1690 is a device which may display price information as an image on a display. The information display unit 1690 may display the changed price information according to reception of the price data change information. Particularly, the information display unit 1690 may display price information as a barcode.

Thereby, the goods purchase apparatus 100 or the mobile terminal 600 may confirm the changed price information by scanning the barcode image in the information display unit 1690.

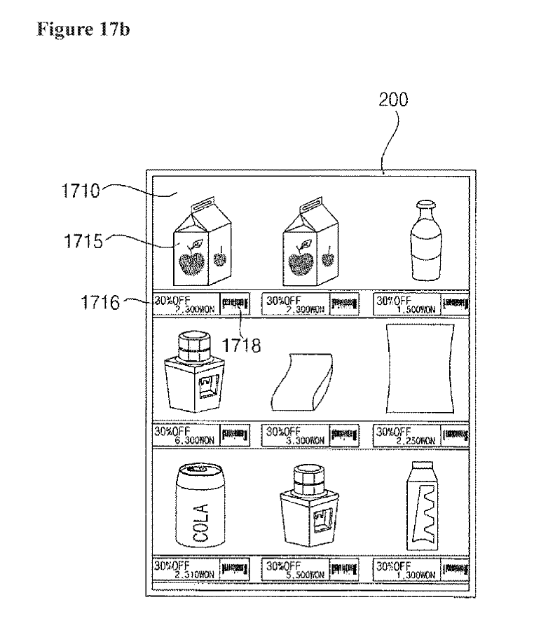

FIGS. 17A to 19 are views illustrating operation of the digital signage.

First, FIG. 17A exemplarily illustrates the digital signage 200 disposed at the front end of the goods display stand 201. The digital signage 200 may display a image 1710 including images of goods disposed in the goods display stand 201 and information regarding the goods.

Particularly, the image 1710 may display images and information of goods, promotion of which is underway, among the goods displayed in the goods display stand 201.

FIG. 17B is an enlarged view of the image 1710 of FIG. 17A.

FIG. 17B exemplarily illustrates that the image 1710 displays goods images 1715, discount information 1716, price information, and barcode images 1718.

A user may conveniently shop with reference to the image and information displayed on the digital signage 200.

For example, if the goods purchase apparatus 100 scans a barcode image 1718 displayed on the digital signage 200, corresponding goods may be added to a goods purchase list.

The image 1710 displayed on the digital signage 200 may be changed to a image displaying information regarding other goods.

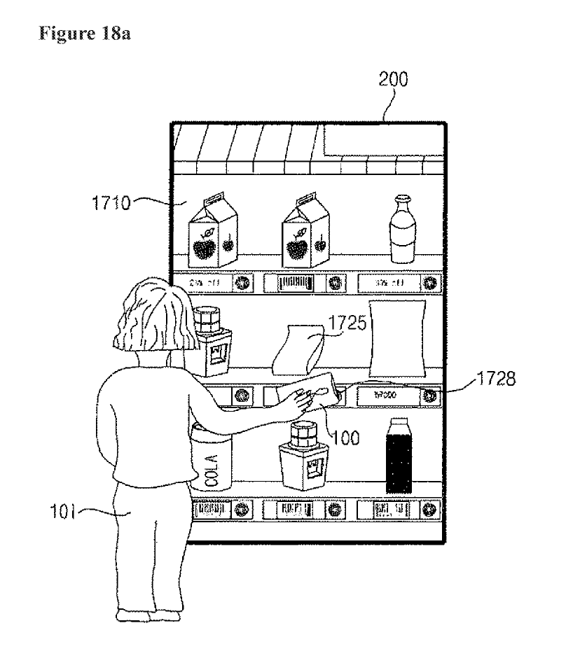

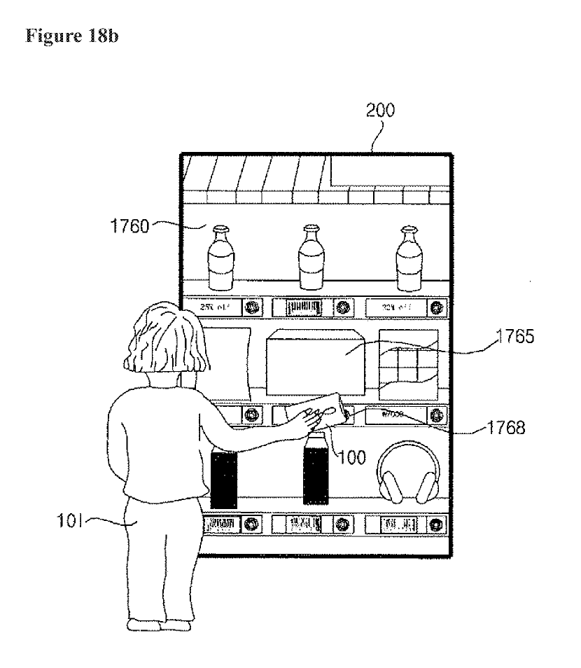

FIG. 18A exemplarily illustrates display of the first image 1710 on the digital signage 200, and FIG. 18B exemplarily illustrates display of a second image 1760 on the digital signage 200.

The first image 1710 of FIG. 18A is a image displayed at a first time and may include images, price information, discount information, barcode images, etc. of goods of a first group.

FIG. 18A exemplarily illustrates that a user 101 scans a barcode image 1728 of a first goods image 1725 using the goods purchase apparatus 100. Thereby, first goods may be added to the goods purchase list.

The second image 1710 of FIG. 18B is a image displayed at a second time and may include images, price information, discount information, barcode images, etc. of goods of a second group.

FIG. 18B exemplarily illustrates that the user 101 scans a barcode image 1768 of a second goods image 1765 using the goods purchase apparatus 100. Thereby, second goods may be added to the goods purchase list.

Conversion of the first image 1710 of FIG. 18A into the second image 1760 of FIG. 18B may be automatically performed after a designated time has elapsed or be performed by user input.

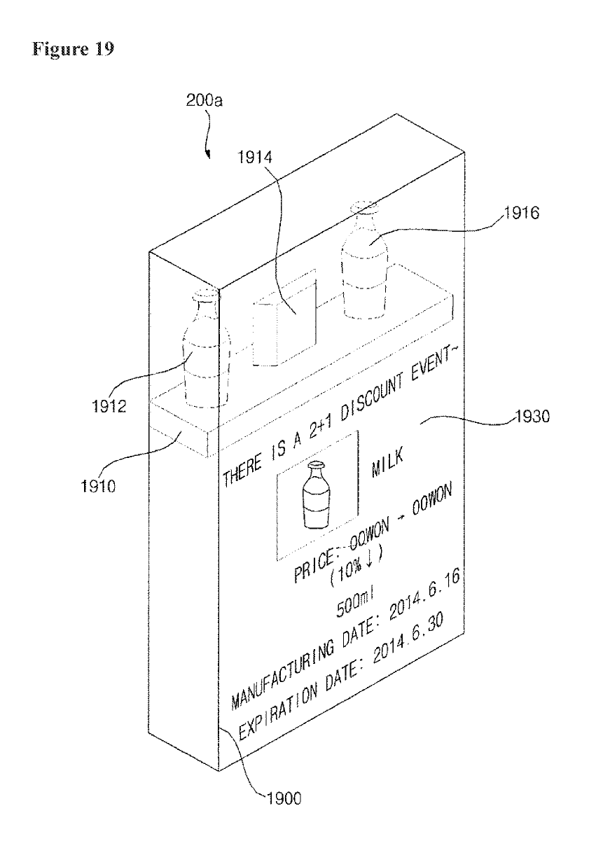

FIG. 19 exemplarily illustrates a digital signage 200a including a transparent display 1900.

With reference to FIG. 19, in a showcase type digital signage 200a, respective goods 1912, 1914, and 1916 may be displayed on a goods display stand 1910 and the transparent display 1900 may be disposed on the front surface of the goods display stand 1910.

The transparent display 1900 may display a image 1930 including price information, thumbnail images, discount information, manufacture date information, and expiration date information of the respective goods 1912, 1914, and 1916. Thereby, a user may confirm both actual goods and various pieces of information thereof.

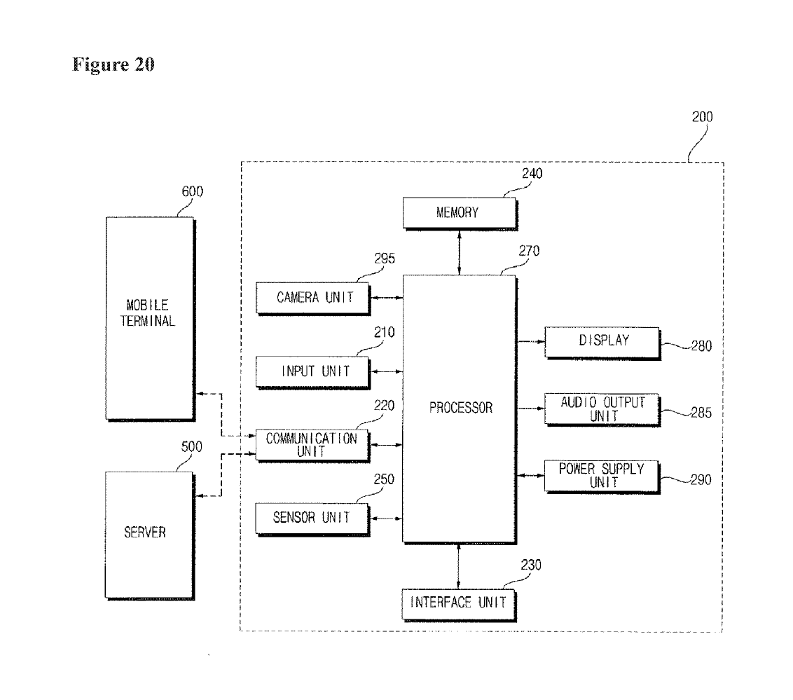

Each of the digital signages 200 and 200a of FIGS. 17A to 19 may include a display implemented as an LCD or an OLED, a processor, and a communication unit. The configuration of the digital signage will be described in detail with reference to FIG. 20.

FIG. 20 is one exemplary block diagram illustrating the digital signage of FIG. 1.

The digital signage 200 of FIG. 20 may include an input unit 210, a communication unit 220, an interface unit 230, a memory 240, a sensor unit 250, a processor 270, a display 280, an audio output unit 285, a power supply unit 290, and a camera unit 295. The signage 200 may further include an audio input unit (not shown).

The input unit 210 may include a plurality of buttons or a touchscreen attached to the digital signage 200. The digital signage 200 may be turned on through the plurality of buttons or the touchscreen, thus being operated. In addition, various input operations may be performed through the input unit 210.

The communication unit 220 may exchange data with the goods purchase apparatus 100, the mobile terminal 600, or the server 500 through wireless communication methods. Various data communication methods, such as Bluetooth, WiFi direct, WiFi, DLNA, APiX, etc., may be used as wireless data communication methods.

The communication unit 220 may receive goods information, such as goods images and price information corresponding to a goods display stand, from the server 500 and transmit the received goods information to the processor 270 or the memory 240.

Otherwise, the communication unit 220 may transmit user's goods purchase information to the server 500.

The interface unit 230 may receive data from the outside or transmit a signal processed or generated by the processor 270 to the outside through various methods rather than the communication unit 220. For example, the interface unit 230 may exchange data with the outside through wired methods. For this purpose, the interface unit 230 may include a high definition multimedia interface (HDMI) terminal, an RGB terminal, a USB terminal, etc.

The memory 240 may store various pieces of data for overall operation of the digital signage 200 including a program for processing or control through the processor 270. Further, the memory 240 may temporarily store images or information received from the outside.

The sensor unit 250 may sense user touch input or contact between the mobile terminal 600 and the digital signage 200. For this purpose, the sensor unit 250 may include a touch sensor, a position sensor, a motion sensor, or a gyro sensor.

The sensed user touch input or gesture input may be input to the processor 270.

The audio output unit 285 converts an electrical signal from the processor 270 into an audio signal and outputs the audio signal. For this purpose, the audio output unit 285 may include a speaker. The audio output unit 285 may output a sound corresponding to the input unit 210, i.e., operation of a button.

The audio input unit (not shown) may receive a user's voice. For this purpose, the audio input unit (not shown) may include a microphone. The audio input unit (not shown) may convert the received voice into an electrical signal and transmit the electrical signal to the processor 270. The processor 270 may control overall operation of the respective units of the digital signage 200.

Particularly, the processor 270 may control the display 280 to display the images and information of goods received from the server 500. Here, the processor 270 may receive a moving image and control the display 280 to display the moving image.

Further, the processor 270 may receive recommended goods information from the server 500 and control the display 280 to display the recommended goods information.

The processor 270 may control the sensor unit 250 and the camera 295 unit to transmit sensed user's position information to the server 500.

The processor 270 may calculate a user's position based on an image captured by the camera unit 295.

Further, the processor 270 may control change of the positions of the displayed images or information according to the calculated user's position information, control 3D display of the images or information, control variation of depth in 3D display, or control variation of a tilting angle in 3D display.

The display 280 may be implemented as a PDP, an LCD, or an OLED or perform flexible display or 3D display.

The power supply unit 290 may supply power required to operate the respective elements of the digital signage 200 under control of the processor 270. Particularly, the power supply unit 290 may supply power to the processor 270 implemented as a system on chip (SOC) type, the display 280 displaying an image, and the audio output unit 285 to output audio.

For this purpose, the power supply unit 290 may include a converter (not shown) converting AC power into DC power. Further, for example, if the display 280 is implemented as a liquid crystal panel including a plurality of backlight lamps, the power supply unit 290 may further include an inverter (not shown) performing PWM operation to vary luminance and to perform dimming.

The camera unit 295 may include one camera or a plurality of cameras. An image captured by the camera unit 295 may be transmitted to the processor 270 and the processor 270 may perform user confirmation, user position confirmation, gesture recognition, etc. by performing signal processing of the captured image.

The digital signage 200 described in the specification may include a TV receiver, a monitor, or a projector.

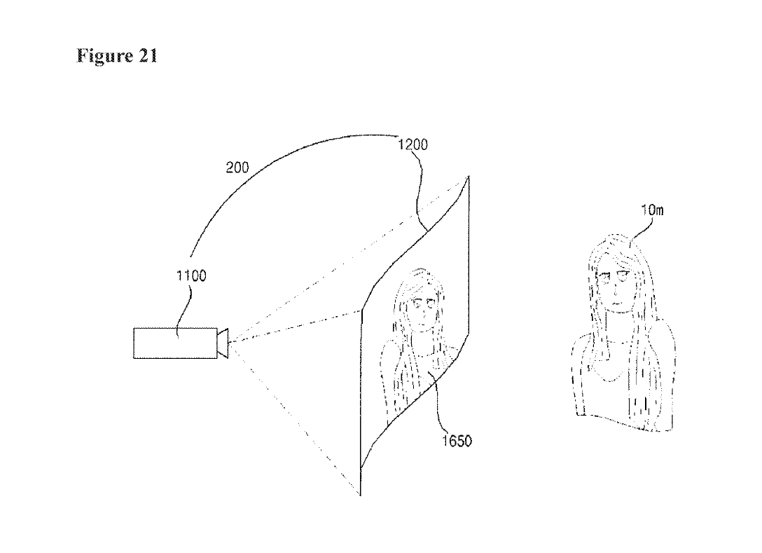

FIG. 21 is a view exemplarily illustrating the concept of a digital signage having an image projection module in accordance with one embodiment of the present invention.

With reference to FIG. 21, the digital signage 200 may include an image projection module 1100 and a screen 1200.

The image projection module 1100 may output a projected image based on visible light to the outside.

Further, the image projection module 110 may output light to detect a distance from an external target object to the outside through first direction scanning and second direction scanning, receive light corresponding to the output light, and detect the distance from the external target object or the movement of the external target object based on the output light and the received light. Here, the output light may be infrared light.

The image projection module 1100 may output both the projected image based on visible light and the output light to the outside. For this purpose, the image projection module 100 may include a 2D scanner outputting the projected image based on visible light together with the output light to the outside by a scanning method through first direction scanning and second direction scanning.

Since a user 10m located at the opposite side to the image projection module 1100 recognizes an image projected on the screen 1200, such a method may be referred to as a rear projection method.

Since the images of various goods provided by the mart 500 are displayed as the projected image, the user 10m may recognize information regarding the various goods.

Detection of a distance from the user 10m located in front of the screen 1200 may be performed based on light output in the direction of the screen 1200.

As one example, if the user 10m located in front of the screen 1200 performs touch input, i.e., touches the screen 1200, using a finger, as exemplarily shown in FIG. 21, the image projection module 1100 may receive light scattered or reflected by the user's finger and sense the touch input based on the output light and the received light.

As another example, if the user 10m located in front of the screen 1200 performs gesture input to the screen 1200 using a user's hand, as exemplarily shown in FIG. 21, the image projection module 1100 may receive light scattered or reflected by the user's hand and sense the gesture input based on the output light and the received light.

The digital signage 200 including the image projection module 1100 in accordance with the embodiment of the present invention may output images of respective goods as a projected image based on visible light, output light to detect touch input or gesture input, and sense the touch input or the gesture input.

For example, the image projection module 1100 in the digital signage 200 outputs images of respective goods as a projected image based on visible light and calculates position information of touch input using the goods purchase apparatus 100 or gesture input using the goods purchase apparatus 100, performed around one goods image among a plurality of goods images. Thereby, the digital signage 200 may decide purchase of one of the plural goods and transmit the purchase decision information to the goods purchase apparatus 100 held by the user 10m. Then, the goods purchase apparatus 100 may transmit the purchase decision information to the server 500. Otherwise, the digital signage 200 including the image projection module 1100 in accordance with the embodiment of the present invention may output images of respective goods as a projected image based on visible light and output light as information of the respective goods. When the user 10m brings the goods purchase apparatus 100 close to one goods image among a plurality of goods images displayed on the digital signage 200, the digital signage 200 may receive output light (infrared light) outputting information of the corresponding goods. Then, the goods purchase apparatus 100 decides purchase of the corresponding goods based on the received output light. After decision of purchase of the corresponding goods, the goods purchase apparatus 100 may transmit purchase information to the server 500.

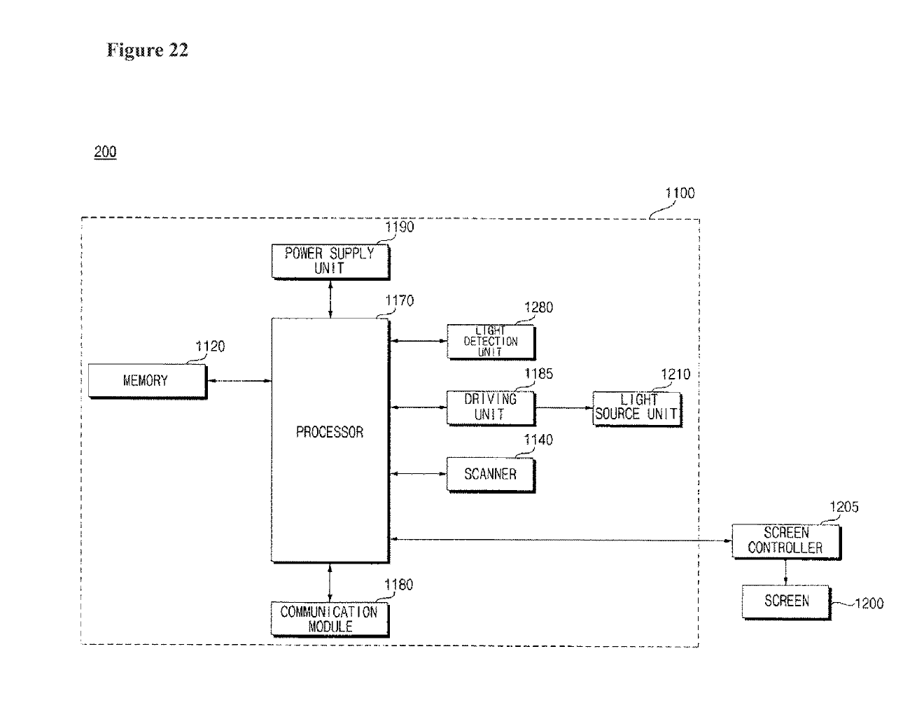

FIG. 22 is one exemplary block diagram briefly illustrating the inside of the image projection module of FIG. 21.

With reference to FIG. 22, the image projection module 1100 may output a projected image and output light using a time of flight (TOF) method.

For this purse, the image projection module 1100 may include a memory 1120, a scanner 1140, a processor 1170, a communication module 1180, a driving unit 1185, a power supply unit 1190, a light source unit 1210, and a light detection unit 1280.

The memory 1120 may store a program for processing or control through the processor 1170 and perform a function to temporarily store input or output data (for example, a moving image, a still image, etc.).

The communication module 1135 serves as an interface with all external devices connected to the image projection module 1100 by wire or wirelessly. The communication module 1135 may receive data or power transmitted or supplied from these external devices, transmit the received data or power to the respective elements of the image projection module 1100, and transmit data within the image projection module 110 to the external devices.

Particularly, the communication module 1135 may receive a wireless signal from an adjacent mobile terminal (not shown). Here, the wireless signal may include various types of data including a voice call signal, a video phone call signal, text data, and image data.

The scanner 1140 may sequentially and repeatedly perform first direction scanning and second direction scanning of input light and then output light to the outside.

Light input to the scanner 1140 may include visible light corresponding to a projected image and output light for distance detection of an external target object. Here, the output light may be infrared light.

The scanner 1140 may perform scanning of the overall external scan region in the unit of a frame while sequentially and repeatedly performing scanning in a direction from left to right and scanning in a direction from right to left in the external scan region. Further, the scanner 1140 may output a projected image based on visible light and output light to the external scan region through such scanning.

The processor 1170 may perform overall control operation of the image projection module 1100.

In more detail, the processor 1170 may control operations of the respective units of the image projection module 1100.

The processor 1170 may control output of a video image related to goods images or goods information stored in the memory 1120 or a video image related to goods images or foods information received from the server 500 through the communication module 1135 as a projected image.

For this purpose, the processor 1170 may control the driving unit 1185 controlling the light source unit 1210 outputting visible light including red (R), green(G), and blue (B) light. In more detail, the processor 1170 may output R, G, and B signals corresponding to a video image to be displayed to the driving unit 1185.

In order to detect a distance from an external target object, the processor 1170 may transmit an electrical signal corresponding to output light to the driving unit 1185.

The processor 1170 may control operation of the scanner 1140. In more detail, the processor 170 may output a projected image and output image to the outside by sequentially and repeatedly performing first direction scanning and second direction scanning.

The processor 1170 may vary a frame rate and thus vary a scanning speed of the scanner 1140 when the processor 1170 controls operation of the scanner 1140.

The processor 1170 may perform detection of a distance from an external target object based on an electrical signal corresponding to output light transmitted to the driving unit 1185 and an electrical signal corresponding to light received by the light detection unit 1280.

For example, the processor 1170 may detect a distance from the external scan region using a phase difference between the electrical signal corresponding to the output light and the electrical signal corresponding to the received light. Further, the processor 1170 may detect a user's gesture motion based on distance information of the external scan region detected in the unit of a frame.

In more detail, the processor 1170 may cause the screen 1200 to have first transparency during a first frame section and process touch input during the first frame section, and cause the screen 50 to have second transparency lower than the first transparency during a second frame section and process gesture input during the second frame section.

Further, the processor 1170 may control a screen controller 1205 controlling the screen 1200 at the outside of the image projection module 1100.

The screen 1200 may have the first transparency during the first frame section and have the second transparency lower than the first transparency during the second frame section. In more detail, the screen 1200 becomes opaque during the first frame section so that a projected image may be displayed on the screen 1200, and the screen 1200 becomes transparent during the second frame section so that output light may pass through the screen 1200 and a user located in front of the screen 1200 may be detected.

Such adjustment of transparency of the screen 1200 according to frame sections may be performed by the screen controller 1205.

If the screen 1200 includes a first transparent electrode and a second transparent electrode intersecting each other and an anisotropic substance disposed between the first transparent electrode and the second transparent electrode, the screen controller 1205 may vary the alignment direction of the anisotropic substance according to power applied between the first transparent electrode and the second transparent electrode and thus control the screen 1200 to have first transparency during the first frame section and to have second transparency during the second frame section.

A frame synchronization signal may be transmitted from the processor 1170 to the screen controller 1205.

The light source unit 1210 may include a blue light source unit outputting blue light, a green light source unit outputting green light, and a red light source unit outputting red light. The respective light source units may be implemented as laser diodes. Otherwise, the respective light source units may be implemented as LEDs.

Further, the light source unit 1210 may include an infrared light source unit outputting infrared light.

The light detection unit 1280 may convert light received from the outside into an electrical signal corresponding to output light. For this purpose, the light detection unit 1280 may include photodiodes converting an optical signal into a reception signal, i.e., an electrical signal.

If infrared light is output as output light, in order to receive infrared light as received light, the light detection unit 1280 may include a charge coupled device (CCD) or a CMOS sensor.

Although not shown in FIG. 22, a sampler (not shown) converting an analog signal into a digital signal may be further provided between the light detection unit 1280 and the processor 1170.

The driving unit 1185 may control the red light source unit, the green light source unit, and the blue light source unit within the light source unit 1210 to output red light, green light, and blue light, in response to R, G, and B signals received from the processor 1170.

The driving unit 1185 may control the infrared light source unit within the light source unit 1210 to output infrared light in response to output light received from the processor 1170.

The power supply unit 1190 may receive external power or internal power under control of the controller 1170 and supply power required to operate the respective elements of the image projection module 1100.

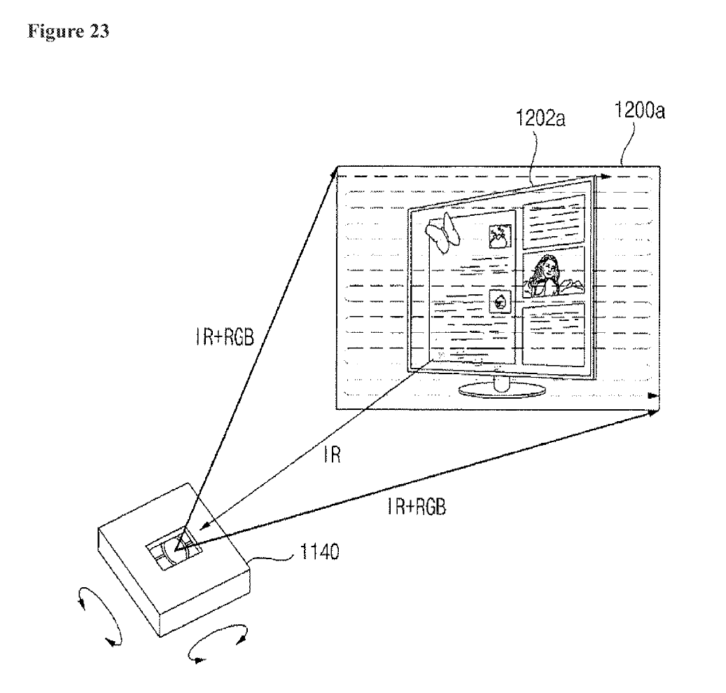

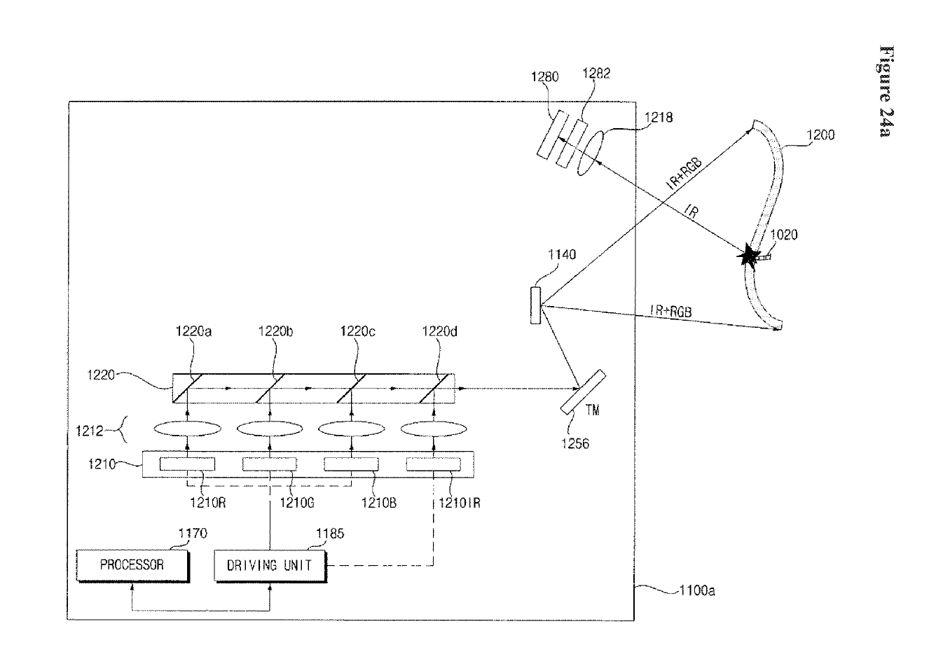

FIG. 23 is a view illustrating simultaneous output of a projected image and light for distance detection from the image projection module of FIG. 21.

With reference to FIG. 23, the scanner 1140 within the image projection module 1100 in accordance with the embodiment of the present invention may sequentially and repeatedly perform first direction scanning and second direction scanning of input light and output light to the external scan region. FIG. 23 exemplarily illustrates that a projected image 1202a and output light IR are output through the screen 1200.

The scanner 1140 within the image projection module 1100 in accordance with the embodiment of the present invention may simultaneously output a projected image based on input visible light (RGB) and infrared light (IR) as output light. Particularly, the scanner 1140 may perform scanning of the overall external scan region in the unit of a frame while sequentially and repeatedly performing scanning in a direction from left to right and scanning in a direction from right to left in the external scan region.

That is, the image projection module 1100 in accordance with the embodiment of the present invention may detect a distance from an external target object while projecting an image toward the outside and thus, display a related image based on the distance from the object or movement of the object or display an image corresponding to a user's gesture.

Hereinafter, the inside of the image projection module 1100 will be described in more detail.

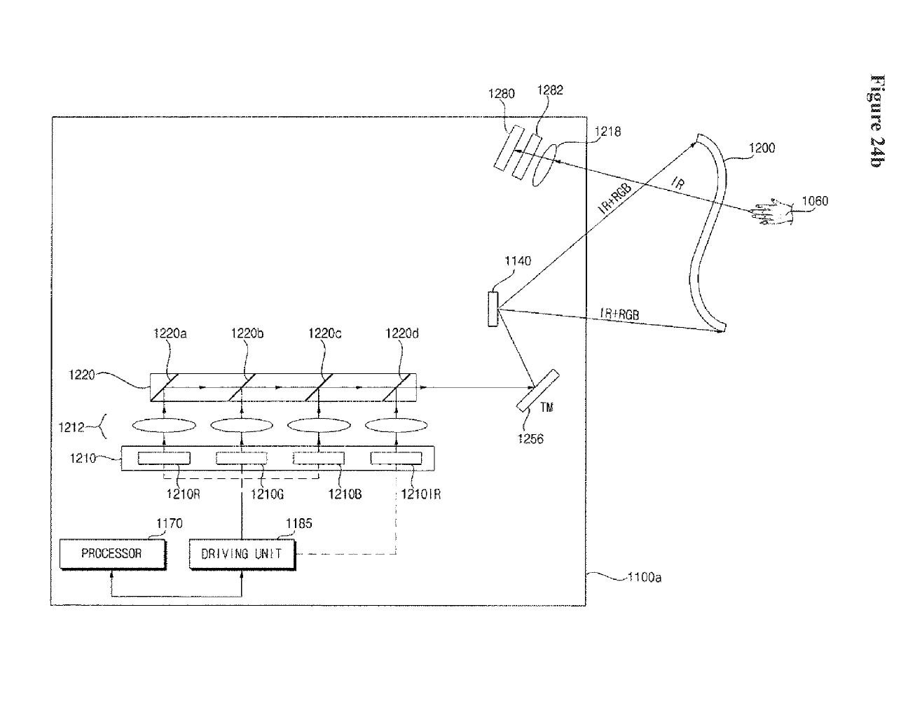

FIGS. 24A and 24B are views illustrating sensing of touch input and gesture input by the image projection module of FIG. 21.

Image projection modules 1100a of FIGS. 24A and 24B are the same and may include a light source unit 1210, an optical condensation unit 1212, an optical unification unit 1210, an optical reflection unit 1256, a scanner 1140, a processor 1170, a driving unit 1185, an optical condensation unit 1218, an infrared transmission filter 1281, and a light detection unit 1280.

The light source unit 1210 may include a plurality of light source units. That is, the light source unit 1210 may include a red light source unit 1210R, a green light source unit 1210G, a blue light source unit 1210B, and an output light source unit 12101R outputting infrared light as output light. The red, green, and blue light source units 1210R, 1210G, and 1210B may include laser diodes.

The respective light source units 1210R, 1210G, 1210B, 12101R may be operated by respective electrical signals from the driving unit 1185, and these electrical signals may be generated under control of the processor 1170. The output light source unit 12101R may output light by an electrical signal corresponding to the output light.

Light output from the respective light source units 1210R, 1210G, 1210B, 12101R is collimated through respective collimator lenses within the optical condensation unit 1212.

The optical unification unit 1220 unifies light output from the respective light source units 1210R, 1210G, 1210B, 12101R and outputs the light in one direction. For this purpose, the optical unification unit 1220 may include four 2D MEMS mirrors 1220a, 1220b, 1220c, and 1220d.

That is, the first optical unification unit 1220a, the second optical unification unit 1220b, the third optical unification unit 1220c, and the fourth optical unification unit 1220d output red light output from the red light source unit 1210R, green light output from the green light source unit 1210G, blue light output from the blue light source unit 1210B, and output light output from the output light source unit 12101R, in the direction of the scanner 1140.

The optical reflection unit 1256 reflects the red light, the green light, the blue light, and the output light, having passed through the optical unification unit 1220, in the direction of the scanner 1140. The optical reflection unit 1256 may reflect light of various wavelengths and, for this purpose, be implemented as a total mirror (TM).

The scanner 1140 may receive visible light (RGB) and output light (IR) from the light source unit 1210 and sequentially and repeatedly perform first direction scanning and second direction scanning to the outside. Such a scanning operation may be repeatedly performed over the entirety of the external scan region. Particularly, the visible light (RGB) and the output light (IR) output from the scanner 110 may be output to the screen 1200.

Thereby, a projected image corresponding to the visible light (RGB) may be displayed on the screen 1200.

Since a user located at the opposite side to the image projection module 1100 recognizes an image projected on the screen 1200, such a method may be referred to as a rear projection method.

Detection of a distance from the user located in front of the screen 1200 may be performed based on the output light output to the screen 1200.

In detail, the image projection module senses touch input by a user's finger 1020 touching the screen 1200 during the first frame section and senses gesture input based on movement of a user's hand 1060 located at the opposite side of the screen 1200 during the second frame section.

For this purpose, the screen 1200 may become opaque during the first frame section and become transparent during the second frame section.

FIG. 24A exemplarily illustrates that the screen 1200 becomes opaque during the first frame section. At this time, the image projection module 1100 may output both a projected image (RGB) by visible light and output light (IR). If the user performs touch input on the screen 1200 by moving a user's finger 1020, the output light (IR) may be scattered or reflected by the user's finger 1020 and thus, received light may be incident upon the image projection module 1100. In more detail, the received light may be input to the light detection unit 1280 via the optical condensation unit 1218 and the infrared transmission filter 1282.

The light detection unit 1280 may convert such received light into an electrical signal, and the processor 1170 may perform distance detection and touch input processing based on the received light by the user's finger 1020 and the output light.

FIG. 24B exemplarily illustrates that the screen 1200 becomes transparent during the second frame section. At this time, the image projection module 1100 may output light (IR).

Otherwise, the image projection module 1100 may output both a projected image (RGB) by visible light and output light (IR). If the user performs gesture input in front of the screen 1200 by moving a user's hand 1060, the output light (IR) may be scattered or reflected by the user's hand 1060 and thus, received light may be incident upon the image projection module 1100. In more detail, the received light may be input to the light detection unit 1280 via the optical condensation unit 1218 and the infrared transmission filter 1282.

The light detection unit 1280 may convert such received light into an electrical signal, and the processor 1170 may perform distance detection and gesture input processing based on the received light by the user's hand 1060 and the output light.

The first frame section and the second frame section may be alternately disposed. However, the first frame section and the second frame section are limited thereto and disposition of the first frame section and the second frame section may be variously modified.

In accordance with the embodiment of the present invention, since the scanner 1140 outputs visible light (RGB), although the screen 1200 on which a projected image is displayed has a free-form surface, the projected image may be displayed so as to correspond to the free-form surface of the corresponding screen 1200. For example, the curved surface state of the screen 1200 may be detected through distance detection due to output light, scaling of a displayed image corresponding to the curved surface is performed, and the scaled projected image may be displayed. Thereby, a free-form surface display may be implemented.

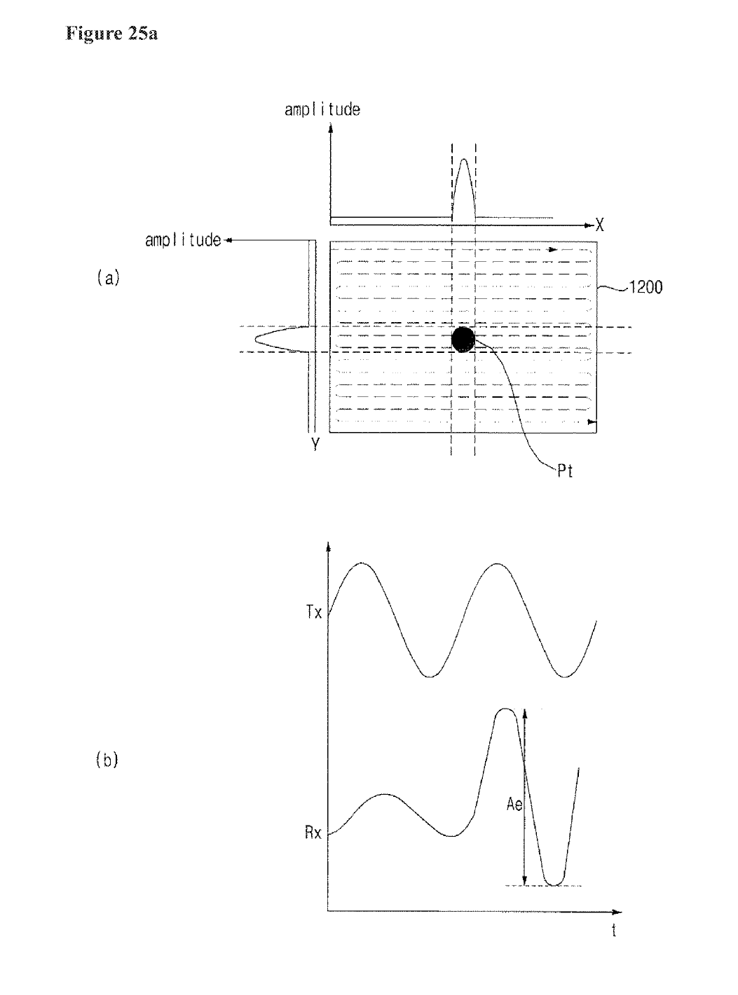

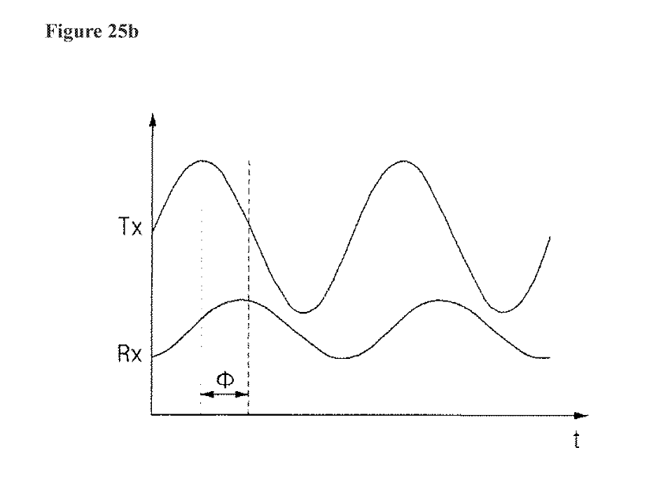

FIGS. 25A(a), 25A(b), and 25B are views illustrating a distance detection method in the image projection module of FIGS. 24A and 24B.

First, FIGS. 25A(a) and 25A(b) are views illustrating sensing of touch input on the screen 1200 of FIG. 24A during the first frame section.

If a user touches a first point P1 on the screen 1200 under the condition that light is output to the screen 1200, for example, using a user's hand, as exemplarily shown in FIG. 25A(a), the output light is scattered or reflected by the user's hand and is received by the light detection unit 1280.

FIG. 25A(a) exemplarily illustrates that the amplitudes of the received light at x and y coordinates corresponding to the first point P1 are increased.

FIG. 25A(b) exemplarily illustrates an electrical signal (Tx) of the output light and an electrical signal (Rx) of the received light, particularly, the amplitudes (Ae) of the received light at x and y coordinates corresponding to the first point P1. That is, the amplitude of the electrical signal of received light at a point touched by the user is higher than that of electrical signals at other points on the screen.

Using such characteristics, the processor 1170 may detect and process a touch point on the screen 1200. Particularly, the processor 1170 may calculate coordinates of touch input if the screen 1200 has first transparency.

Next, FIG. 25b is a view illustrating sensing of gesture input performed in front of the screen 1200 of FIG. 24B during the second frame section.

Here, Tx represents an electrical signal of output light, and Rx represents an electrical signal of received light by a user's gesture in front of the screen 1200.

If the screen transmits output light, output light according to input of a gesture of a user's hand 1060 located in front of the screen 1200 may be received by the image projection module 1100. Further, the processor 1170 may calculate distance information according to a phase difference Φ between the electrical signal of the output light and the electrical signal of the received light and process the gesture input based on the distance information.

The block diagram of the inside of the above-described purchased goods calculation apparatus 32 may be the same as the block diagram of the inside of the digital signage of FIG. 20.

That is, the purchased goods calculation apparatus 32 may include an input unit (not shown), a communication unit (not shown), an interface unit (not shown), a memory (not shown), a sensor unit (not shown), a processor (not shown), a display (not shown), an audio output unit (not shown), a power supply unit (not shown), and a camera unit (not shown). The signage purchased goods calculation apparatus 32 may further include an audio input unit (not shown). Hereinafter, among the respective elements of the purchased goods calculation apparatus 32, only the elements differing from the elements of the digital signage will be described.

The communication unit (not shown) may exchange data with the membership card, the goods purchase apparatus 100 or the mobile terminal 600 which the user possesses, or the server 500 through a wireless method. For example, the communication unit (not shown) may receive user information by wireless communication, such as NFC communication, based tagging with the membership card, the goods purchase apparatus 100 or the mobile terminal 600 which the user possesses and receive a purchase list of goods purchased by the user by connection to the server 500 according to reception of the user information.

The processor (not shown) controls overall operation of the respective units within the purchased goods calculation apparatus 32.

Particularly, if the communication unit (not shown) may receive user information by wireless communication, such as NFC communication, based tagging with the membership card, the goods purchase apparatus 100 or the mobile terminal 600 which the user possesses, the processor (not shown) may control the communication unit (not shown) so as to receive the purchase list of goods purchased by the user from the server 500.

Further, the processor (not shown) may perform payment according to user input of selection of a payment method. The processor (not shown) may transmit a payment request signal to the server 500 using card information which has been registered in advance.

Further, the processor (not shown) may control the display (not shown) so as to display a image to divide the purchased goods into goods to be delivered to home and goods to be directly carried by hand, before payment.

For example, the processor (not shown) may transmit information of the goods to be directly carried to the server 500 and thus, may notify the server 500 of information of the goods to be directly carried. Further, the processor (not shown) may control receipt of the corresponding goods in the counter zone 30.

The operating method of the goods purchase apparatus of the present invention may be implemented as code readable by the processor provided in the display apparatus for vehicles in a recording medium readable by the processor. The recording medium readable by the processor may be any kind of recording device in which data readable by the processor are stored. For example, the recording medium readable by the processor may include a ROM, a RAM, a CD-ROM, a magnetic tape, a floppy disk, an optical data storage medium, or a carrier wave, such as data transmission over the Internet. Further, since the recording medium readable by the processor may be distributed in a computer system connected through a network, code readable by the processor in a distributed manner may be stored and executed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention may be applied to a goods purchase apparatus and a goods purchase system having the same and, more particularly, to a goods purchase apparatus allowing a user to simply shop at a mart and a goods purchase system having the same.

1. A goods purchase apparatus comprising:
a communication unit, when the goods purchase apparatus is tagged with a user's membership card or mobile terminal, to receive user information from the membership card or the mobile terminal;
an image capture unit to scan images representing information related to goods in a mart or goods displayed on a digital signage; and
a controller to control to transmit the user information to a server, to extract goods information based on the scanned images, and to control to transmit goods purchase information corresponding to the goods information to the server.

2. The goods purchase apparatus according to claim 1, wherein:
the communication unit receives ID information, assigned corresponding to the user information, from the server; and
the controller transmits the ID information to the server during transmission of the goods purchase information.

3. The goods purchase apparatus according to claim 2, wherein the controller, when the goods purchase apparatus passes through an entry authentication apparatus located in an entrance zone in the mart, transmits the user information or the ID information to the server.

4. The goods purchase apparatus according to claim 1, further comprising an audio input unit,
wherein the controller transmits goods purchase number information or goods purchase cancellation information, based on a user's voice input through the audio input unit, to the server.

5. The goods purchase apparatus according to claim 1, wherein the image capture unit scans a user's fingerprint and the controller transmits the scanned fingerprint image to the server.

6. A goods purchase system comprising:
a digital signage disposed in a shopping zone in a mart and to provide a plurality of goods images and information related to the plurality of goods images;
a goods purchase apparatus to scan images representing information related to goods in the mart or goods displayed on the digital signage or transmit goods purchase information to the outside based on a user's voice;
a server to store a goods purchase list based on the goods purchase information; and
a calculation apparatus to receive the goods purchase list from the server, to divisionally display goods to be delivered and goods to be carried directly among the goods purchase list, and to perform payment for the goods purchase list.

7. The goods purchase system according to claim 6, wherein the calculation apparatus receives the goods purchase list from the server based on tagging with the goods purchase apparatus.

8. The goods purchase system according to claim 6, wherein the goods purchase apparatus receives user information by tagging with a user's membership card, transmits the user information to the server, and receives ID information assigned by the server.

9. The goods purchase system according to claim 6, further comprising an entry authentication apparatus located in an entrance zone in the mart, to receive user information or ID information of a user from the goods purchase apparatus, and to transmit the received user information or ID information to the server.

10. The goods purchase system according to claim 9, wherein the entry authentication apparatus, when the goods purchase apparatus exits the entrance zone, receives the goods purchase list of the corresponding apparatus from the server and performs payment for the goods purchase list.

11. The goods purchase system according to claim 6, wherein the information provided by the digital signage includes at least one of mart provided price information, online mall price information, similar goods information, customer-based recommended goods information, and mart provided promotion information.

12. The goods purchase system according to claim 6, wherein the digital signage includes:
a showcase having goods displayed therein; and
a transparent display disposed on the front surface of the showcase and
to display information related to the displayed goods.

13. The goods purchase system according to claim 6, wherein the digital signage receives the plurality of goods images and price information corresponding to the plurality of goods images from the server and displays the received goods images and price information.

14. The goods purchase system according to claim 6, wherein the digital signage:
displays a first image, including images, price information, discount information, and barcode images of goods of a first group, at a first time; and
displays a second image, including images, price information, discount information, and barcode images of goods of a second group, at a second time.

15. The goods purchase system according to claim 6, wherein the digital signage includes:
an image projection module to output the plurality of goods images as a projected image based on visible light, to output light to detect touch input or gesture input, and to sense the touch input or the gesture input; and
a screen to display the projected image.

16. The goods purchase system according to claim 15, wherein the image projection module calculates position information of the touch input or the gesture input using the goods purchase apparatus based on the output light, decides purchase of one of the plurality of displayed goods images based on the position information, and transmits the purchase decision information to the server or the goods purchase apparatus.

17. The goods purchase system according to claim 15, wherein:
the image projection module to output images of respective goods as the projected image based on visible light, and to output information related to the respective gods as the output light; and
the goods purchase apparatus receives the output light and transmits purchase information of one of the plurality of goods based on the received output light to the server.

18. The goods purchase system according to claim 6, wherein the goods purchase list displayed on the calculation apparatus includes images representing goods items, price information and purchase number information of the goods, and an object representing purchase or deletion of each goods.

19. The goods purchase system according to claim 6, wherein the calculation apparatus displays a delivery method set image including an available delivery time item and a delivery date/time selection item.

20. The goods purchase system according to claim 19, wherein the delivery method set image further includes a batch delivery item, a group delivery selection item, a confirmation item, and a cancellation item.
